(19) United States
(12) Patent Application Publication
(10) Pub. No.: US 2026/0172725 A1
(43) Pub. Date: Jun. 18, 2026

(54) SOLID-STATE IMAGING DEVICE

(71) Applicant: SONY SEMICONDUCTOR SOLUTIONS CORPORATION, KANAGAWA (JP)

(72) Inventor: HIDEAKI MOGI, KANAGAWA (JP)

(21) Appl. No.: 19/128,611

(22) PCT Filed: Sep. 25, 2023
(86) PCT No.: PCT/JP2023/034720

§ 371 Date: May 9, 2025

(30) Foreign Application Priority Data
Nov. 16, 2022 (JP) 2022-183411

(51) Int. Cl. H04N 25/79; H04N 25/76

(52) U.S. Cl. CPC H04N 25/79; H04N 25/76

(57) ABSTRACT

A solid-state imaging device includes a pixel and an operating voltage supply section. The pixel includes a photoelectric conversion layer, a charge accumulation/transfer layer, a charge accumulation electrode, and an electrode. The photoelectric conversion layer converts light into electric charge. The charge accumulation/transfer layer is provided on the photoelectric conversion layer, and accumulates and transfers the electric charge. The charge accumulation electrode is provided on the charge accumulation/transfer layer on a side opposite to the photoelectric conversion layer. The electrode is provided on the photoelectric conversion layer on a side opposite to the charge accumulation/transfer layer. The operating voltage supply section selectively supplies one of a first operating voltage and a second operating voltage to the pixel. The second operating voltage is different from the first operating voltage.

### TECHNICAL FIELD The present disclosure relates to a solid-state imaging device.

### BACKGROUND ART

PTL 1 discloses an imaging device. In this imaging device, a first pixel including a first pixel electrode, and a second pixel including a second pixel electrode with a smaller area than an area of the first pixel electrode are arranged. An auxiliary electrode is formed around the second pixel electrode of the second pixel. The auxiliary electrode allows for voltage control, and allows for fine adjustment of sensitivity.

In the imaging device configured in such a manner, it is possible to obtain, in the same accumulation time, outputs that are different in brightness from each other with use of signals imaged by the first pixel and the second pixel that are different in sensitivity from each other. It is possible to output an image with a high dynamic range by combining two kinds of signals that are different in brightness from each other.

In addition, when respective voltages of the first pixel and the second pixel are the same as each other, high dynamic range outputting is not performed, and all pixels have the same normal pixel characteristic.

### CITATION LIST

### Patent Literature

PTL 1: Japanese Unexamined Patent Application Publication No. 2021-36668

### SUMMARY OF THE INVENTION

In the imaging device disclosed in PTL 1 described above, in order to expand a dynamic range, a dedicated pixel arrangement is necessary that includes the first pixel and the second pixel respectively including the first pixel electrode and the second pixel electrode that are different in area from each other. In such a dedicated pixel arrangement, a signal obtained by the second pixel is decreased. Accordingly, there is room for improvement in resolution and an electric charge accumulation amount. In addition, in the imaging device, configurations of the first pixel and the second pixel are asymmetric. Accordingly, there is room for improvement in oblique incidence resistance in a case where the imaging device is applied to a longitudinal spectroscopic sensor. Further, with the progress of miniaturization of pixels, it is difficult to ensure an area difference between the first pixel electrode and the second pixel electrode, and it is difficult to obtain a sensitivity difference between the first pixel and the second pixel.

It is therefore desirable to develop a solid-state imaging device that makes it possible to expand a dynamic range and perform imaging with no necessity of a dedicated pixel arrangement.

A solid-state imaging device according to a first aspect of the present disclosure includes a pixel and an operating voltage supply section. The pixel includes a photoelectric conversion layer, a charge accumulation/transfer layer, a charge accumulation electrode, and an electrode. The photoelectric conversion layer converts light into electric charge. The charge accumulation/transfer layer is provided on the photoelectric conversion layer, and accumulates and transfers the electric charge. The charge accumulation electrode is provided on the charge accumulation/transfer layer on a side opposite to the photoelectric conversion layer. The electrode is provided on the photoelectric conversion layer on a side opposite to the charge accumulation/transfer layer. The operating voltage supply section selectively supplies one of a first operating voltage and a second operating voltage to the pixel. The second operating voltage is different from the first operating voltage.

In a solid-state imaging device according to a second aspect of the present disclosure, the operating voltage supply section supplies the first operating voltage to a part of a plurality of pixels arranged, and supplies the second operating voltage to another part of the plurality of pixels arranged, in the solid-state imaging device according to the first aspect.

In a solid-state imaging device according to a third aspect of the present disclosure, the operating voltage supply section is constructed to include a voltage generator, a voltage supply section, and a voltage selector, in the solid-state imaging device according to the first aspect. The voltage generator generates the first operating voltage and the second operating voltage. The voltage supply section supplies, to the pixel, one of the first operating voltage and the second operating voltage generated by the voltage generator. The voltage selector selects one of the first operating voltage and the second operating voltage to be supplied to the pixel by the voltage supply section.

### BRIEF DESCRIPTION OF THE DRAWINGS

FIG. 1 is a schematic plan view (a chip layout diagram) of a solid-state imaging device according to a first embodiment of the present disclosure.

FIG. 2 is a longitudinal cross-sectional view of the solid-state imaging device and a pixel illustrated in FIG. 1.

FIG. 3 is a schematic plan view of pixels including a block configuration of an operating voltage supply section upon normal shooting in the solid-state imaging device illustrated in FIG. 2.

FIG. 4 is a schematic plan view, corresponding to FIG. 3, of the pixels including the block configuration of the operating voltage supply section upon high dynamic range driving in the solid-state imaging device illustrated in FIG. 2.

FIG. 5 is a graph illustrating a relationship between an operating voltage to be supplied to an charge accumulation electrode when an electrode of the pixel is at a low voltage, and an electric charge accumulation amount in the solid-state imaging device illustrated in FIG. 2.

FIG. 6 is a graph, corresponding to FIG. 5, illustrating a relationship between the operating voltage to be supplied to the charge accumulation electrode when the electrode of the pixel is at a high voltage, and the electric charge accumulation amount in the solid-state imaging device illustrated in FIG. 2.

FIG. 7A is a schematic longitudinal cross-sectional view of the pixel illustrated in FIG. 2 upon normal shooting.

FIG. 7B is an energy potential diagram of the pixel illustrated in FIG. 7A.

FIG. 8A is a schematic longitudinal cross-sectional view, corresponding to FIG. 7A, of the pixel illustrated in FIG. 2 upon high dynamic range driving.

FIG. 8B is an energy potential diagram, corresponding to FIG. 7B, of the pixel illustrated in FIG. 8A.

FIG. 9A is a schematic longitudinal cross-sectional view, corresponding to FIGS. 7 and 8, of the pixel illustrated in FIG. 2 upon photoelectric conversion.

FIG. 9B is an energy potential diagram in a state in which a first operating voltage is supplied in the pixel illustrated in FIG. 9A.

FIG. 9C is an energy potential diagram in a state in which a second operating voltage is supplied in the pixel illustrated in FIG. 9A.

FIG. 10A is a schematic longitudinal cross-sectional view, corresponding to FIGS. 7 and 8, of the pixel illustrated in FIG. 2 upon electric charge accumulation.

FIG. 10B is an energy potential diagram, corresponding to FIG. 9B, in a state in which the first operating voltage is supplied in the pixel illustrated in FIG. 10A.

FIG. 10C is an energy potential diagram, corresponding to FIG. 9C, in a state in which the second operating voltage is supplied in the pixel illustrated in FIG. 10A.

FIG. 11A is a schematic longitudinal cross-sectional view, corresponding to FIGS. 7 and 8, of the pixel illustrated in FIG. 2 upon electric charge transfer.

FIG. 11B is an energy potential diagram, corresponding to FIG. 9B, in a state in which the first operating voltage is supplied in the pixel illustrated in FIG. 11A.

FIG. 11C is an energy potential diagram, corresponding to FIG. 9C, in a state in which the second operating voltage is supplied in the pixel illustrated in FIG. 11A.

FIG. 12 is a graph illustrating a relationship between an operating voltage to be supplied to an electrode of a pixel and sensitivity in a solid-state imaging device according to a second embodiment of the present disclosure.

FIG. 13 is a longitudinal cross-sectional view, corresponding to FIG. 2, of a pixel of a solid-state imaging device according to a third embodiment of the present disclosure.

FIG. 14 is a longitudinal cross-sectional view, corresponding to FIG. 2, of a pixel of a solid-state imaging device according to a fourth embodiment of the present disclosure.

FIG. 15 is a longitudinal cross-sectional view, corresponding to FIG. 2, of a pixel of a solid-state imaging device according to a fifth embodiment of the present disclosure.

FIG. 16 is a longitudinal cross-sectional view, corresponding to FIG. 2, of a pixel of a solid-state imaging device according to a sixth embodiment of the present disclosure.

FIG. 17 is a plan view of the pixel illustrated in FIG. 16.

FIG. 18 is a block diagram of an electronic apparatus according to a seventh embodiment of the present disclosure.

FIG. 19 is a configuration diagram of a photodetection system including a photodetector according to an eighth embodiment of the present disclosure.

FIG. 20 is a circuit configuration diagram of the photodetection system illustrated in FIG. 19.

FIG. 21 is a block diagram depicting an example of schematic configuration of a vehicle control system.

FIG. 22 is a diagram of assistance in explaining an example of installation positions of an outside-vehicle information detecting section and an imaging section.

FIG. 23 is a view depicting an example of a schematic configuration of an endoscopic surgery system.

FIG. 24 is a block diagram depicting an example of a functional configuration of a camera head and a camera control unit (CCU).

### MODES FOR CARRYING OUT THE INVENTION

Hereinafter, description is given in detail of embodiments of the present disclosure with reference to the drawings. It is to be noted that the description is given in the following order.

### 1. First Embodiment

A first embodiment describes a first example in which the present technology is applied to a solid-state imaging device. The first embodiment describes an overall configuration of the solid-state imaging device, a configuration of a pixel, and an imaging operation of the pixel.

### 2. Second Embodiment

A second embodiment describes a second example in which a method of supplying an operating voltage to be supplied to the pixel is changed in the solid-state imaging device according to the first embodiment.

### 3. Third Embodiment

A third embodiment describes a third example in which a cross-sectional structure of the pixel is changed in the solid-state imaging device according to the first embodiment.

### 4. Fourth Embodiment

A fourth embodiment describes a fourth example in which the cross-sectional structure of the pixel is changed in the solid-state imaging device according to the first embodiment.

### 5. Fifth Embodiment

A fifth embodiment describes a fifth example in which the cross-sectional structure of the pixel is changed in the solid-state imaging device according to the first embodiment.

### 6. Sixth Embodiment

A sixth embodiment describes a sixth example in which the cross-sectional structure of the pixel is changed in the solid-state imaging device according to the first embodiment.

### 7. Seventh Embodiment

A seventh embodiment is a seventh example in which the present technology is applied to an electronic apparatus including the solid-state imaging device according to any of the first embodiment to the sixth embodiment.

### 8. Eighth Embodiment

An eighth embodiment describes an eighth example in which the present technology is applied to a photodetection system including the solid-state imaging device according to any of the first embodiment to the sixth embodiment.

### 9. Example of Application to Mobile Body

The application example describes an example in which the present technology is applied to a vehicle control system that is an example of a mobile body control system.

### 10. Example of Application to Endoscopic Surgery System

The application example describes an example in which the present technology is applied to an endoscopic surgery system.

### 11. Other Embodiments

### 1. First Embodiment

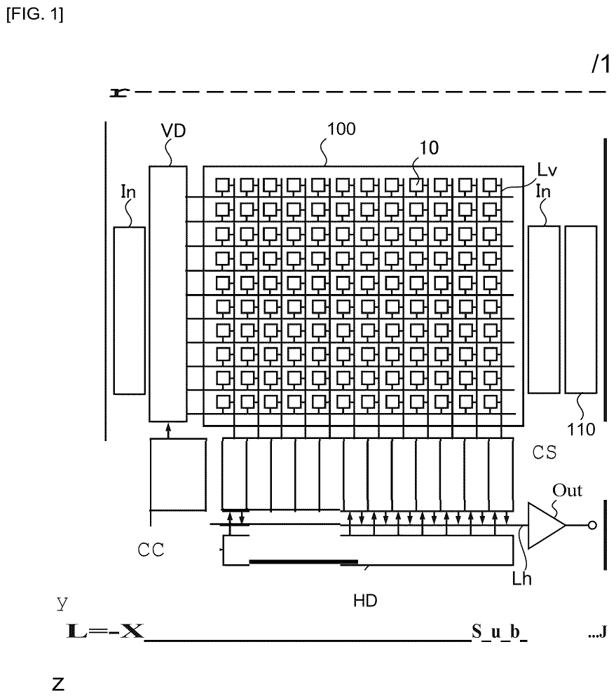

Description is given of a solid-state imaging device 1 according to the first embodiment of the present disclosure with reference to FIGS. 1 to 6, FIG. 7A, FIG. 7B, FIG. 8A, FIG. 8B, FIGS. 9A to 9C, FIGS. 10A to 10C, and FIGS. 11A to 11C.

Here, an arrow-X direction indicated as appropriate in the drawings indicates one planar direction of the solid-state imaging device 1 placed on a plane for convenience. An arrow-Y direction indicates another planar direction orthogonal to the arrow-X direction. In addition, an arrow-Z direction indicates an upward direction orthogonal to the arrow-X direction and the arrow-Y direction. That is, the arrow-X direction, the arrow-Y direction, and the arrow-Z direction exactly coincide with an X-axis direction, a Y-axis direction, and a Z-axis direction, respectively, of a three-dimensional coordinate system.

It is to be noted that these directions are each indicated to aid understanding of descriptions, and are not intended to limit directions used in the present technology.

### Configuration of Solid-State Imaging Device 1

### (1) Overall Configuration of Solid-State Imaging Device 1

FIG. 1 illustrates an example of a schematic planar configuration of the solid-state imaging device 1 according to the first embodiment. Here, the solid-state imaging device 1 is a CMOS solid-state imaging device. In addition, the solid-state imaging device 1 is a photodetector that converts incident light incident from the outside into electric charge.

The solid-state imaging device 1 mainly includes a semiconductor substrate Sub, e.g., an Si substrate. The solid-state imaging device 1 includes, on the semiconductor substrate Sub, a pixel region (a pixel array section) 100 in which a plurality of pixels 10 is two-dimensionally and regularly arranged, and a peripheral circuit. In the pixel region 100, the plurality of pixels 10 is arranged in the arrow-X direction and the arrow-Y direction.

The pixel 10 includes an unillustrated photoelectric conversion element that converts incident light into electric charge, and a plurality of pixel transistors. The pixel transistors are each configured by what is called an insulated-gate field-effect transistor (IGFET).

The plurality of pixel transistors includes at least three transistors, e.g., a transfer transistor, a reset transistor, and an amplification transistor. In addition, the pixel transistors may include four transistors by further adding a selection transistor.

An equivalent circuit of a unit pixel is similar to that of a normal one, and detailed illustration and description thereof are therefore omitted.

In addition, the pixel 10 may have a shared pixel structure. The shared pixel structure includes a plurality of photoelectric conversion elements, a plurality of transfer transistors, one shared floating diffusion, and a shared pixel transistor.

The peripheral circuit includes a vertical drive circuit VD, a column signal processing circuit CS, a horizontal drive circuit HD, an output circuit Out, a control circuit CC, and the like.

The control circuit CC receives an input clock and data instructing an operation mode or the like, and outputs data such as internal information about the solid-state imaging device 1. That is, the control circuit CC generates, on the basis of a vertical synchronization signal, a horizontal synchronization signal, and a master clock, clock signals and control signals that serve as a standard for operations of the vertical drive circuit VD, the column signal processing circuit CS, the horizontal drive circuit HD, and the like. Thereafter, these signals are inputted to the vertical drive circuit VD, the column signal processing circuit CS, the horizontal drive circuit HD, and the like.

The vertical drive circuit VD includes, for example, a shift register. The vertical drive circuit VD selects a pixel drive wiring, and supplies a pulse for driving the pixel 10 to the selected pixel drive wiring. The pixels 10 are driven on a row-by-row basis. That is, the vertical drive circuit VD sequentially and selectively scans the pixels 10 of the pixel region 100 in a vertical direction on a row-by-row basis. Signal charge generated in response to an amount of received light in the photoelectric conversion element of each of the pixels 10 is supplied as a pixel signal to the column signal processing circuit CS through a vertical signal line Lv.

The column signal processing circuit CS is provided for, for example, each column of the pixels 10. In the column signal processing circuit CS, signal processing such as noise removal is performed for each pixel column on signals outputted from the pixels 10 in one row. That is, the column signal processing circuit CS performs signal processing such as CDS (Correlated Double Sampling) to remove a fixed pattern noise unique to the pixel 10, signal amplification, or AD conversion. An unillustrated horizontal selection switch is coupled between an output stage of the column signal processing circuit CS and a horizontal signal line Lh.

The horizontal drive circuit HD includes, for example, a shift register. The horizontal drive circuit HD sequentially outputs horizontal scanning pulses to thereby sequentially select the respective column signal processing circuits CS, and outputs the pixel signals from the respective column signal processing circuits CS to the horizontal signal line Lh.

The output circuit Out performs signal processing on signals sequentially supplied from the respective column signal processing circuits CS through the horizontal signal line Lh, and outputs the signals. For example, in a case where only buffering is performed, the output circuit Out may perform black level adjustment, column dispersion correction, various types of digital signal processing, and the like, in some cases. An input/output terminal In exchanges signals between the solid-state imaging device 1 and the outside thereof.

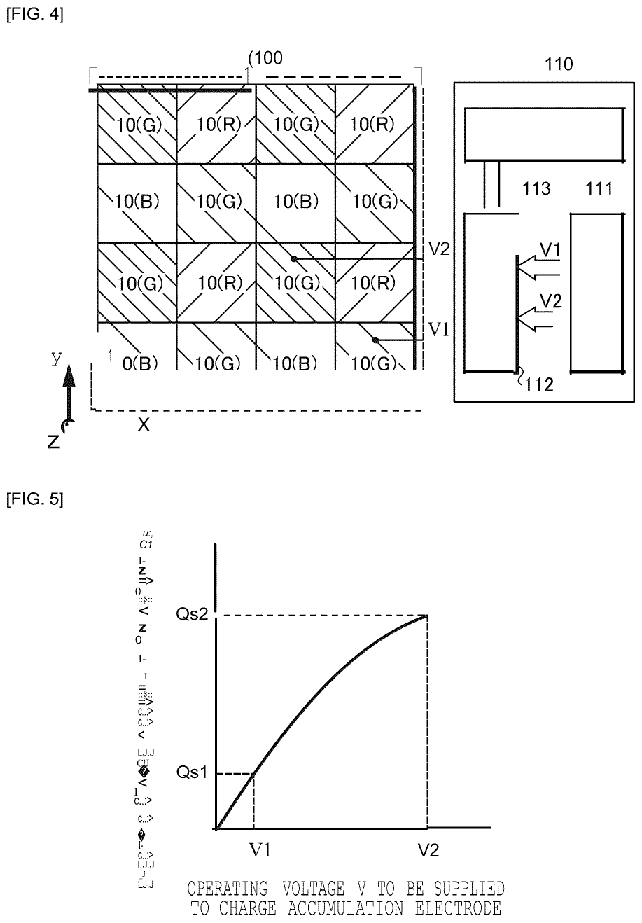

Here, the solid-state imaging device 1 further includes an operating voltage supply section 110 as a peripheral circuit. The operating voltage supply section 110 supplies a first operating voltage V2 (see FIG. 3) to the pixel 10 upon normal shooting, and supplies a second operating voltage V1 (see FIG. 4) to the pixel 10 upon high dynamic range driving.

It is to be noted that a specific configuration of the operating voltage supply section 110 will be described later.

In addition, in the solid-state imaging device 1 illustrated in FIG. 1, the pixel region 100 and the peripheral circuit are provided on the semiconductor substrate Sub. In the present technology, two or more semiconductor substrates Sub may be stacked and a corresponding one of the semiconductor substrates Sub may be provided for each of the pixel region 100 and the peripheral circuit. For example, it is possible to construct the solid-state imaging device 1 in which the peripheral circuit is provided on one semiconductor substrate Sub and the pixel region 100 is provided on the semiconductor substrate Sub stacked on the one semiconductor substrate Sub.

### (2) Configuration of Pixel 10

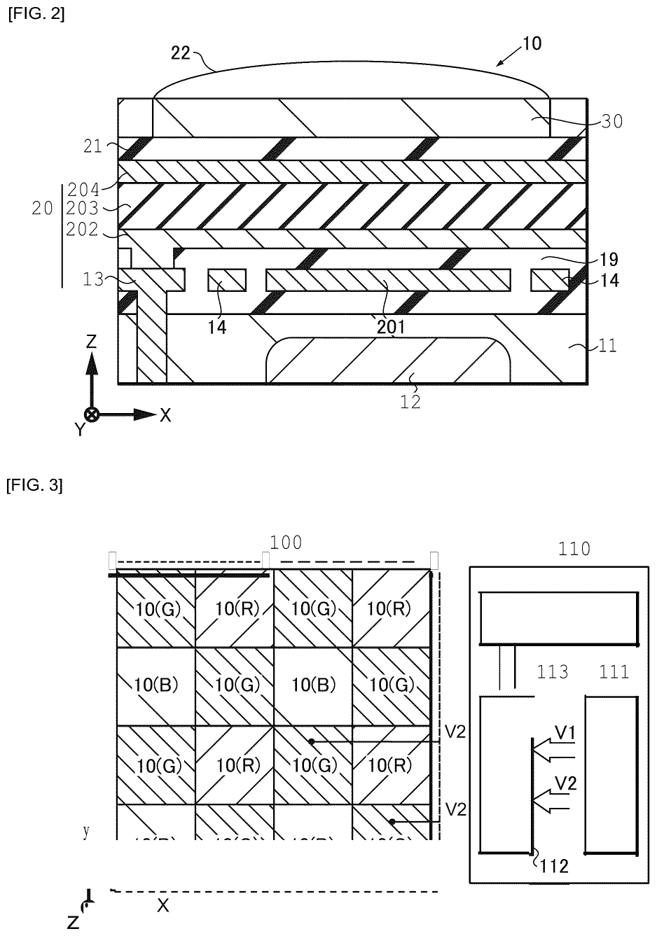

FIG. 2 illustrates an example of a longitudinal cross-sectional configuration of the pixel 10 of the solid-state imaging device 1. FIG. 3 illustrates an example of a schematic planar configuration of the pixels 10 and a portion of the pixel region 100 in the solid-state imaging device 1 upon the normal shooting together with an example of a block configuration of the operating voltage supply section 110.

As illustrated in FIG. 2, the pixel 10 includes a photoelectric conversion region 12 and a photoelectric converter 20 that are sequentially stacked on a semiconductor substrate (refer to a reference symbol Sub indicated in FIG. 1). The solid-state imaging device 1 constructs a stacked image sensor in which the photoelectric converter 20 is stacked on the photoelectric conversion region 12.

As illustrated in FIG. 3, the pixel 10 is formed in a rectangular shape having two sides opposed to each other in the arrow-X direction and two sides opposed to each other in the arrow-Y direction, as viewed in the arrow-Z direction (hereinafter, simply referred to as “in a plan view”).

Further, as illustrated in FIG. 2, the pixel 10 includes an optical lens 22 provided for each pixel 10.

### (3) Configuration of Pixel Separation Electrode 14

Detailed description is given. As illustrated in FIG. 2, in one pixel 10, at least a portion of a periphery is surrounded by a pixel separation electrode 14. The pixel separation electrode 14 is shared by the one pixel 10 and another pixel 10 arranged adjacent to the one pixel 10 in each of the arrow-X direction and the arrow-Y direction.

The pixel separation electrode 14 extends in the arrow-X direction, and is provided to be spaced apart with a certain interval in the arrow-Y direction. In addition, the pixel separation electrode 14 extends in the arrow-Y direction, and is provided to be spaced apart with a certain interval in the arrow-X direction. That is, the pixel separation electrode 14 is formed in a lattice shape in a plan view. The pixel 10 is provided in a region defined by the pixel separation electrode 14 formed in a lattice shape. A fixed voltage is to be supplied to the pixel separation electrode 14.

It is to be noted that, here, the pixel separation electrode 14 is not provided in a region in which a floating diffusion 13 is provided that is shared by adjacent pixels 10.

### (4) Configuration of Photoelectric Conversion Region 12

The photoelectric conversion region 12 is provided in a semiconductor layer 11 stacked on a light incident side of the semiconductor substrate Sub. For example, an Si single crystalline layer is used for the semiconductor layer 11. The semiconductor layer 11 is a p-type semiconductor region doped with a p-type impurity as a first electrically-conductive type.

The photoelectric conversion region 12 is provided in the semiconductor layer 11, and is formed by an n-type semiconductor region of a second electrically-conductive type, which is an electrically-conductive type opposite to the first electrically-conductive type. That is, the photoelectric conversion region 12 includes a p-n junction diode.

### (5) Configuration of Photoelectric Converter 20

As illustrated in FIG. 2, the organic photoelectric conversion section 20 is configured by sequentially stacking, on the semiconductor layer 11, a charge accumulation electrode 201, a charge accumulation/transfer layer 202, a photoelectric conversion layer 203, and an electrode 204. Further, the photoelectric converter 20 includes the floating diffusion 13.

### (5-1) Configuration of Charge Accumulation Electrode 201

The charge accumulation electrode 201 is provided on the semiconductor layer 11 in a region corresponding to the pixel 10. In other words, the charge accumulation electrode 201 is provided between the semiconductor layer 11 and the charge accumulation/transfer layer 202 on the charge accumulation/transfer layer 202 on a side opposite to the photoelectric conversion layer 203. The charge accumulation electrode 201 is provided electrically independently for each of the pixels 10. In other words, the charge accumulation electrode 201 is a lower electrode of the photoelectric converter 20.

In the first embodiment, an operating voltage is supplied to the charge accumulation electrode 201 upon an electric charge accumulation operation of the photoelectric converter 20. As illustrated in FIG. 3, upon the normal shooting in the solid-state imaging device 1, a first operating voltage V2 is supplied to the charge accumulation electrodes 201 of all the pixels 10. The first operating voltage V2 is supplied from the operating voltage supply section 110.

Meanwhile, as illustrated in FIG. 4, upon the high dynamic range driving in the solid-state imaging device 1, the first operating voltage V2 is supplied to the charge accumulation electrodes 201 of a part of the pixels 10 among the plurality of pixels 10, and a second operating voltage V1 is supplied to the charge accumulation electrodes 201 of another part of the pixels 10. Likewise, the second operating voltage VI is supplied from the operating voltage supply section 110.

The charge accumulation electrode 201 accumulates, in the charge accumulation/transfer layer 202, electric charge converted from light in the photoelectric conversion layer 203.

An indium oxide-zinc oxide-based oxide (IZO: Indium Zinc Oxide) or indium tin oxide (ITO: Indium Tin Oxide) is used for the charge accumulation electrode 201. The charge accumulation electrode 201 is formed to have a film thickness of 10 nm or more and 100 nm or less, for example.

### (5-2) Configuration of Charge Accumulation/Transfer Layer 202

The charge accumulation/transfer layer 202 is provided on the charge accumulation electrode 201 with an insulator 19 interposed therebetween. Here, the charge accumulation/transfer layer 202 is formed to be shared across a region corresponding to the plurality of pixels 10. The charge accumulation/transfer layer 202 is a transparent semiconductor that allows an electromagnetic wave in a visible light range to pass therethrough. The electric charge converted from light in the photoelectric conversion layer 203 is accumulated in the charge accumulation/transfer layer 202.

In addition, a portion of the charge accumulation/transfer layer 202 is coupled to the floating diffusion 13. The floating diffusion 13 is coupled to a pixel circuit constructed by an unillustrated pixel transistor.

For the charge accumulation/transfer layer 202, for example, IGZO is used that includes indium (In), gallium (Ga), zinc (Zn), and oxygen (O). In addition, IGSiO including In, Ga, Si, and O, IAZO including In, aluminum (Al), Zn, and O, or the like may be used for the charge accumulation/transfer layer 202.

The charge accumulation/transfer layer 202 is formed to have a film thickness of 10 nm or more and 100 nm or less, for example.

### (5-3) Configuration of Photoelectric Conversion Layer 203

The photoelectric conversion layer 203 is provided on the charge accumulation/transfer layer 202. As with the charge accumulation/transfer layer 202, here, the photoelectric conversion layer 203 is formed to be shared across the region corresponding to the plurality of pixels 10. The photoelectric conversion layer 203 converts incident light into electric charge.

An organic material is used for the photoelectric conversion layer 203. As the organic material, there may be used any of a p-type organic semiconductor, an n-type organic semiconductor, a stacked structure of a p-type organic semiconductor and an n-type organic semiconductor, and a mixture (bulk hetero structure) of a p-type organic semiconductor and an n-type organic semiconductor.

The stacked structure includes a stacked structure in which the p-type organic semiconductor, the mixture (bulk hetero structure) of the p-type organic semiconductor and the n-type organic semiconductor, and the n-type organic semiconductor are stacked. In addition, the stacked structure includes a stacked structure in which the p-type organic semiconductor and the mixture (bulk hetero structure) of the p-type organic semiconductor and the n-type organic semiconductor are stacked. Further, the stacked structure includes a stacked structure in which the n-type organic semiconductor and the mixture (bulk hetero structure) of the p-type organic semiconductor and the n-type organic semiconductor are stacked. It is to be noted that the stacking order of the stacked structure may be changed as appropriate.

Examples of the p-type organic semiconductor may include a naphthalene derivative, an anthracene derivative, a phenanthrene derivative, a pyrene derivative, a perylene derivative, a tetracene derivative, a pentacene derivative, a quinacridone derivative, a thiophene derivative, a thienothiophene derivative, a benzothiophene derivative, a benzothienobenzothiophene derivative, a triallylamine derivative, a carbazole derivative, a perylene derivative, a picene derivative, a chrysene derivative, a fluoranthene derivative, a phthalocyanine derivative, a subphthalocyanine derivative, a subporphyrazine derivative, a metal complex including a heterocyclic compound as a ligand, a polythiophene derivative, a polybenzothiadiazole derivative, and a polyfluorene derivative.

Examples of the n-type organic semiconductor include a fullerene and a fullerene derivative ((e.g., fullerenes (higher fullerenes) such as C60, C70, and C74, endohedral fullerene, etc.), or a fullerene derivative (e.g., a fullerene fluoride, a PCBM fullerene compound, a fullerene multimer, etc.)), an organic semiconductor having HOMO and LUMO larger (deeper) than the p-type organic semiconductor, and a transparent inorganic metal oxide.

As the n-type organic semiconductor, there may be specifically used a heterocyclic compound containing a nitrogen atom, an oxygen atom, or a sulfur atoms. Examples of the heterocyclic compound include organic molecules including, as a portion of a molecular skeleton, a pyridine derivative, a pyrazine derivative, a pyrimidine derivative, a triazine derivative, a quinoline derivative, a quinoxaline derivative, an isoquinoline derivative, an acridine derivative, a phenazine derivative, a phenanthroline derivative, a tetrazole derivative, a pyrazole derivative, an imidazole derivative, a thiazole derivative, an oxazole derivative, an imidazole derivative, a benzimidazol derivative, a benzotriazole derivative, a benzoxazole derivative, a benzoxazole derivative, a carbazole derivative, a benzofuran derivative, a dibenzofuran derivative, a subporphyrazine derivative, a polyphenylene vinylene derivative, a polybenzothiadiazole derivative, a polyfluorene derivative, or the like, an organic metal complex, and a subphthalocyanine derivative.

Examples of groups and the like included in the fullerene derivative include: halogen atoms; a straight-chain, branched, or cyclic alkyl group or phenyl group; a group including a straight-chain or condensed aromatic compound; a group including halide; a partial fluoroalkyl group; a perfluoroalkyl group; a silylalkyl group; a silylalkoxy group; an arylsilyl group; an arylsulfanyl group; an alkylsulfanyl group; an arylsulfonyl group; an alkylsulfonyl group; an arylsulfide group; an alkylsulfide group; an amino group; an alkylamino group; an arylamino group; a hydroxy group; an alkoxy group; an acylamino group; an acyloxy group; a carbonyl group; a carboxy group; a carboxamide group; a carboalkoxy group; an acyl group; a sulfonyl group; a cyano group; a nitro group; a group including chalcogenide; a phosphine group; a phosphon group; and derivatives thereof.

A thickness of the photoelectric conversion layer 203 including an organic material is, but not limited to, 1×10⁻⁸ m or more and 5×10⁻⁷ m or less, for example. The thickness of the photoelectric conversion layer 203 is, preferably, 2.5×10⁻⁸ m or more and 3×10⁻⁷ m or less, more preferably, 2.5×10⁻⁸ m or more and 2×10⁻⁷ m or less, and still more preferably, 1×10⁻⁷ m or more and 1.8×10⁻⁷ m or less.

It is to be noted that the organic semiconductors are often classified into p-type and n-type. The p-type means that holes are easily transportable. The n-type means that electrons are easily transportable. Therefore, the organic semiconductor is not limited to the interpretation that it has holes or electrons as majority carriers of thermal excitation, as in inorganic semiconductors.

In addition, examples of a material to form the photoelectric conversion layer 203 that performs photoelectric conversion of light having a green wavelength include a rhodamine-based dye, a merocyanine-based dye, a quinacridone derivative, a subphthalocyanine-based dye (subphthalocyanine derivative), and the like.

In the first embodiment, the photoelectric converter 20 has, for example, a configuration in which light corresponding to a part or all of wavelengths in a visible light region of 400 nm or more and less than 750 nm is absorbed to generate excitons (electron/hole pairs). The photoelectric converter 20 that adopts such a configuration is constructed by sequentially stacking a lower electrode, an insulating layer (an interlayer insulating layer), a semiconductor layer, a hole blocking layer, a photoelectric conversion layer, an electron blocking layer, a work function adjustment layer, and an upper electrode. The lower electrode includes, for example, a readout electrode and an accumulation electrode that are independent of each other. The readout electrode is shared by, for example, four pixels. It is to be noted that the semiconductor layer may be omitted.

Examples of a material to form the photoelectric conversion layer 203 in a case of performing photoelectric conversion of light having a blue wavelength include a coumaric acid dye, tris-8-hydroxyquinoline aluminum (Alq3), a merocyanine-based dye, and the like.

Examples of a material to form the photoelectric conversion layer 203 in a case of performing photoelectric conversion of light having a red wavelength include a phthalocyanine-based dye, a subphthalocyanine-based dye (subphthalocyanine derivative), and the like.

An inorganic material may also be used for the photoelectric conversion layer 203. As the inorganic material, there may be used crystalline silicon, amorphous silicon, microcrystalline silicone, crystalline selenium, amorphous selenium, a chalcopyrite-based compound, or a group III-V compound semiconductor.

Examples of the chalcopyrite-based compound include CIGS (CuInGaSe), CIS (CuInSe₂), CuInS₂, CuAlS₂, CuAlSe₂, CuGaS₂, CuGaSe₂, AgAlS₂, AgAlSe₂, AgInS₂, and AgInSe₂.

Examples of the group III-V compound semiconductor include GaAs, InP, AlGaAs, InGaP, AlGaInP, and InGaAsP. Further examples thereof include CdSe, CdS, In₂Se³, In₂S₃, Bi₂Se₃, Bi₂S₃, ZnSe, ZnS, PbSe, and PbS.

Additionally, quantum dots including these materials may also be used for the photoelectric conversion layer 203.

In addition, the photoelectric conversion layer 203 may be configured by a stacked structure of a lower semiconductor layer and an upper photoelectric conversion layer, although illustration is omitted. Providing the lower semiconductor layer in the photoelectric conversion layer 203 allows the photoelectric conversion layer 203 to prevent recombination upon electric charge accumulation, thus making it possible to improve transfer efficiency of electric charge to the charge accumulation/transfer layer 202. Further, it is possible to effectively suppress generation of a dark current.

For the upper photoelectric conversion layer, selection may be appropriately made from various materials to form the photoelectric conversion layer 203 described above.

Meanwhile, for the lower semiconductor layer, it is preferable to use a material having a large bandgap value (e.g., a bandgap value of 3.0 eV or more) and having higher mobility than that of a material to form the photoelectric conversion layer 203. Specifically, it is possible to use an organic semiconductor material such as the above-described oxide semiconductor material such as IGZO, transition metal dichalcogenide, silicon carbide, diamond, graphene, a carbon nano-tube, a condensed polycyclic hydrocarbon compound, or a condensed heterocyclic compound.

In addition, for the lower semiconductor layer, it is possible to use a material having a larger ionization potential than an ionization potential of the material to form the photoelectric conversion layer 203, in a case where electric charge to be accumulated is an electron.

Meanwhile, for the lower semiconductor layer, it is possible to use a material having a smaller electron affinity than an electron affinity of the material to form the photoelectric conversion layer 203, in a case where electric charge to be accumulated is a hole.

In addition, it is preferable, for the material to form the lower semiconductor layer, to have an impurity concentration of 1×10¹⁸ cm⁻³ or less, for example. The lower semiconductor layer may have a monolayer structure or a multilayer structure. In addition, the material to form the lower semiconductor layer may vary between a region corresponding to the charge accumulation electrode 201 and a region corresponding to the floating diffusion 13.

### (5-4) Configuration of Electrode 204

The electrode 204 is provided on the photoelectric conversion layer 203. In other words, the electrode 204 is provided on the photoelectric conversion layer 203 on a side opposite to the charge accumulation/transfer layer 202. Here, the electrode 204 is formed across a region corresponding to the plurality of pixels 10. The electrode 204 is configured as an upper electrode or an upper transparent electrode in a stacked structure of the photoelectric converter 20. An operating voltage is to be supplied to the electrode 204. The operating voltage to be supplied to the electrode 204 is a fixed voltage in the first embodiment.

As with the charge accumulation electrode 201, for example, IZO or ITO is used for the electrode 204. The electrode 204 is formed to have a film thickness of 20 nm or more and 100 nm or less, for example.

### (6) Configuration of Optical Lens 22

As illustrated in FIG. 2, in the region corresponding to the pixel 10, the optical lens 22 is provided on the electrode 204 of the organic photoelectric converter 20 with a protective film 21 interposed therebetween. The optical lens 22 is formed in a circular shape in a plan view for each of the pixels 10. In addition, the optical lens 22 is formed, for each of the pixels 10, in a curved shape that curves toward the light incident side to condense incident light, as viewed in the arrow-Y direction (hereinafter, referred to as “in a side view”).

That is, the optical lens 22 is what is called an on-chip lens, and is integrally formed for each of the pixels 10 or across the plurality of pixels 10. The optical lens 22 is formed by a transparent resin material, for example.

### (7) Arrangement Configuration of Pixels 10

FIG. 3 illustrates an example of a schematic planar configuration of the pixels 10 including a block configuration of the operating voltage supply section 110 upon the normal shooting in the solid-state imaging device 1. FIG. 4 illustrates an example of a schematic planar configuration of the pixels 10 including the block configuration of the operating voltage supply section 110 upon the high dynamic range driving in the solid-state imaging device 1.

As illustrated in FIGS. 3 and 4, here, in the pixel region 100, pixels 10(B) that convert light having the blue wavelength into electric charge, and pixels 10(G) that convert light having the green wavelength into electric charge are alternately arranged in the arrow-X direction.

The pixels 10(G) that convert light having the green wavelength into electric charge, and pixels 10(R) that convert light having the red wavelength into electric charge are alternately arranged in the arrow-X direction adjacent in the arrow-Y direction to the arrangement of the pixels 10(B) and the pixels 10(G). Two pixels 10(G) adjacent in the arrow-Y direction to each other are arranged to be shifted in the arrow-X direction by one pixel.

(8) Configuration of Operating Voltage Supply Section 110 As illustrated in FIGS. 1, 3, and 4, the solid-state imaging device 1 according to the first embodiment includes the operating voltage supply section 110. As illustrated in FIGS. 3 and 4, the operating voltage supply section 110 includes a voltage generator 111, a voltage supply section 112, and a voltage selector 113.

The voltage generator 111 generates the first operating voltage V2 and the second operating voltage V1. The first operating voltage V2 is, for example, higher than or equal to 4 V and lower than or equal to 6 V. The second operating voltage V1 is a voltage lower than the first operating voltage V2, and is, for example, higher than or equal to 1 V and lower than or equal to 3 V.

The voltage supply section 112 supplies one of the first operating voltage V2 and the second operating voltage V1 generated by the voltage generator 111 to the charge accumulation electrode 201 of the pixel 10.

The voltage selector 113 selects one of the first operating voltage V2 and the second operating voltage V1 to be supplied to the pixel 10 by the voltage supply section 112.

The operating voltage supply section 110 is configured to supply the first operating voltage V2 to all the pixels 10 upon electric charge accumulation in the normal shooting, as illustrated in FIG. 3. The first operating voltage V2 is supplied to the charge accumulation electrodes 201 of the pixels 10.

In addition, as illustrated in FIG. 4, the operating voltage supply section 110 is configured to supply the first operating voltage V2 to a part of the plurality of pixels 10 and supply the second operating voltage V1 to another part of the plurality of pixels 10 upon electric charge accumulation in the high dynamic range driving. The second operating voltage VI is supplied to the charge accumulation electrodes 201 of the pixels 10, as with the first operating voltage V2.

Here, in the first embodiment, the operating voltage supply section 110 is constructed as a hardware structure. That is, the operating voltage supply section 110 is constructed by respective circuits corresponding to the voltage generator 111, the voltage supply section 112, and the voltage selector 113.

It is to be noted that at least a part, e.g., the voltage selector 113, of the operating voltage supply section 110 may be a software structure. For example, in a case where the control circuit CC of the peripheral circuit includes a central processing unit (CPU) and a memory, it is possible to select one of the first operating voltage V2 and the second operating voltage V1 by causing the CPU to execute a program stored in the memory.

Further, the operating voltage supply section 110 may omit a part, e.g., the voltage generator 111, of the configuration, and may be configured to supply one of the first operating voltage V2 and the second operating voltage V1 generated in the outside of the solid-state imaging device 1.

### (9) Relationship Between First Operating Voltage V2, Second Operating Voltage V1, and Accumulated Electric Charge Amount Qs

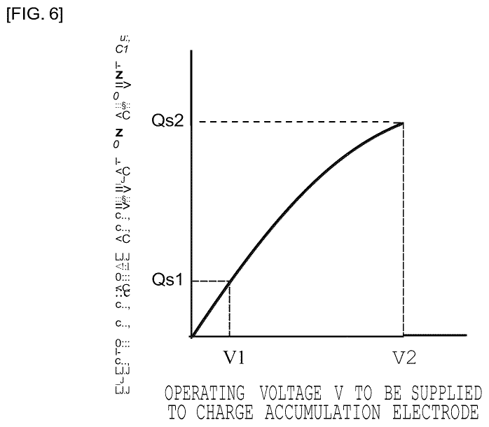

FIG. 5 illustrates an example relationship between the first operating voltage V2 and the second operating voltage VI that are to be supplied to the charge accumulation electrode 201 when the electrode 204 of the pixel 10 is at a low voltage, and an electric charge accumulation amount Qs. FIG. 6 illustrates an example relationship between the first operating voltage V2 and the second operating voltage V1 that are to be supplied to the charge accumulation electrode 201 when the electrode 204 of the pixel 10 is at a high voltage higher than the low voltage, and the electric charge accumulation amount Qs. In FIGS. 5 and 6, a horizontal axis indicates an operating voltage V to be supplied to the charge accumulation electrode 201. Further, a vertical axis indicates the electric charge accumulation amount Qs to be accumulated in the photoelectric converter 20.

As illustrated in FIGS. 5 and 6, an electric charge accumulation amount Qs2 obtained by the first operating voltage V2 is greater than an electric charge accumulation amount Qs1 obtained by the second operating voltage V1. It is to be noted that there is not much difference in the electric charge accumulation amount Qs depending on operation voltages to be supplied to the electrode 204.

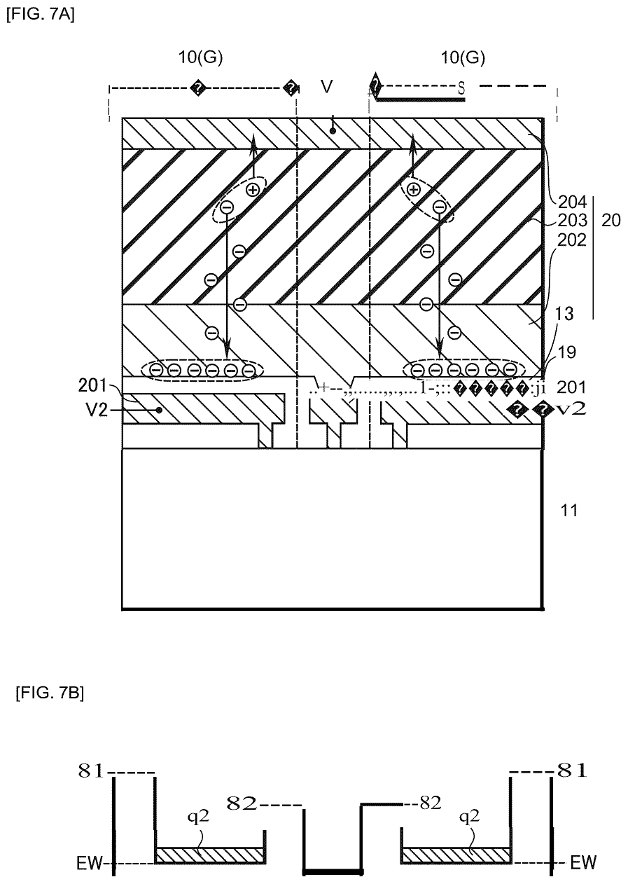

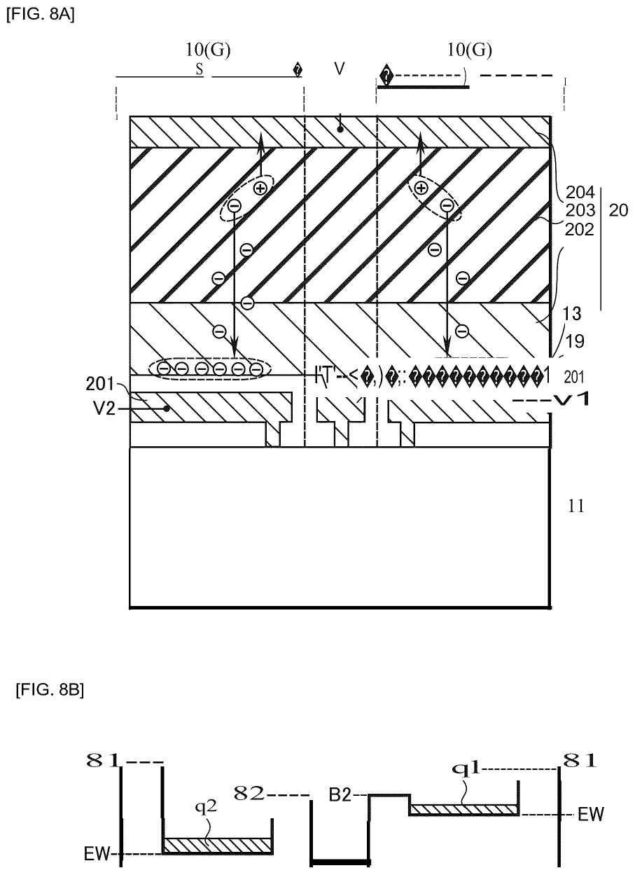

FIG. 7A illustrates an example of a schematic longitudinal cross-sectional configuration of the pixel 10 upon the normal shooting. FIG. 7B illustrates an example of an energy potential of the pixel 10 illustrated in FIG. 7A. FIG. 8A illustrates an example of a schematic longitudinal cross-sectional configuration of the pixel 10 upon the high dynamic range driving. FIG. 8B illustrates an example of an energy potential of the pixel 10 illustrated in FIG. 8A.

As illustrated in FIG. 7A, upon the normal shooting, the first operating voltage V2 is supplied to the charge accumulation electrodes 201 of two pixels 10(G) adjacent in the arrow-Y direction to each other illustrated in FIG. 3. Light incident on the photoelectric conversion layers 203 of the photoelectric converters 20 is converted into electric charge, and holes (+) of electron-hole pairs are absorbed by the electrodes 204, and electrons (−) are accumulated in the charge accumulation/transfer layers 202.

As illustrated in FIG. 7B, the electrons (−) are accumulated as electric charge q2 in an energy potential well B2 surrounded by an energy potential barrier B1 and an energy potential barrier B2. Here, the energy potential barrier B1 is generated by the pixel separation electrode 14. The energy potential barrier B2 is generated by the charge accumulation/transfer layer 202. Further, the energy potential well EW is generated by the charge accumulation electrode 201.

In contrast, as illustrated in FIG. 8A, upon dynamic range driving, the first operating voltage V2 is supplied to the charge accumulation electrode 201 of one of the two pixels 10(G) adjacent in the arrow-Y direction to each other illustrated in FIG. 4, and the second operating voltage V1 is supplied to the charge accumulation electrode 201 of the other pixel 10(G).

In the one pixel 10(G) supplied with the first operating voltage V2, as with the pixel 10(G) illustrated in FIG. 7, the electric charge q2 is accumulated in the energy potential well EW.

In contrast, as illustrated in FIG. 8B, in the other pixel 10(G) supplied with the second operating voltage V1, electric charge q1 less than the electric charge q2 is accumulated in the energy potential well EW. Using a difference between the electric charge q2 and the electric charge q1 makes it possible to expand the dynamic range.

### Operation of Solid-State Imaging Device 1

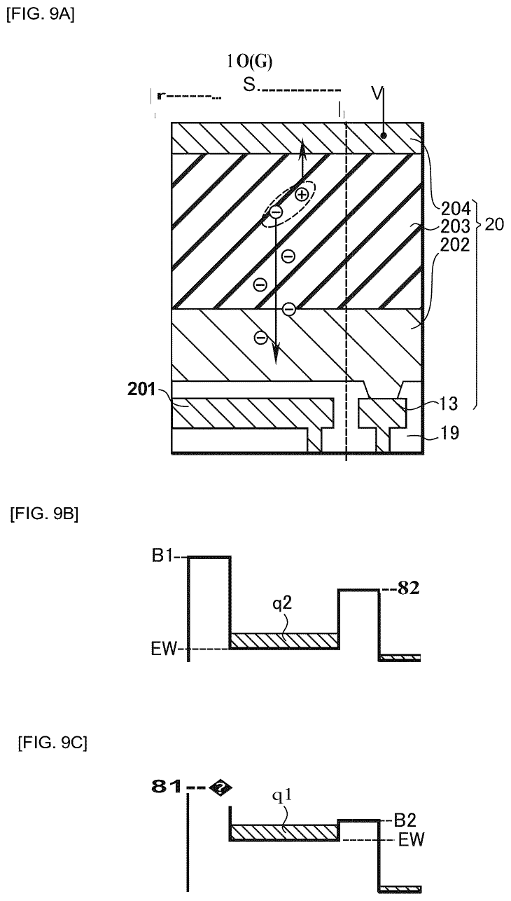

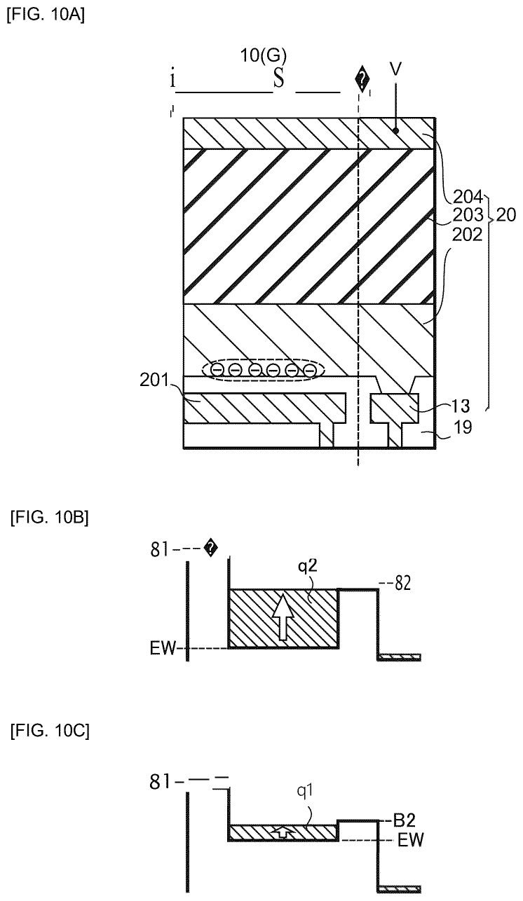

Description is given next of an operation of the solid-state imaging device 1 with reference to FIGS. 9A to 9C, FIGS. 10A to 10C, and FIGS. 11A to 11C.

FIG. 9A illustrates an example of a schematic longitudinal cross-sectional configuration of the pixel 10 upon photoelectric conversion. FIG. 9B illustrates an example of an energy potential in a state in which the first operating voltage V2 is supplied to the pixel 10. FIG. 9C illustrates an example of an energy potential in a state in which the second operating voltage VI is supplied to the pixel 10.

FIG. 10A illustrates an example of a schematic longitudinal cross-sectional configuration of the pixel 10 upon electric charge accumulation. FIG. 10B illustrates an example of an energy potential in the state in which the first operating voltage V2 is supplied to the pixel 10. FIG. 10C illustrates an example of an energy potential in the state in which the second operating voltage V1 is supplied to the pixel 10.

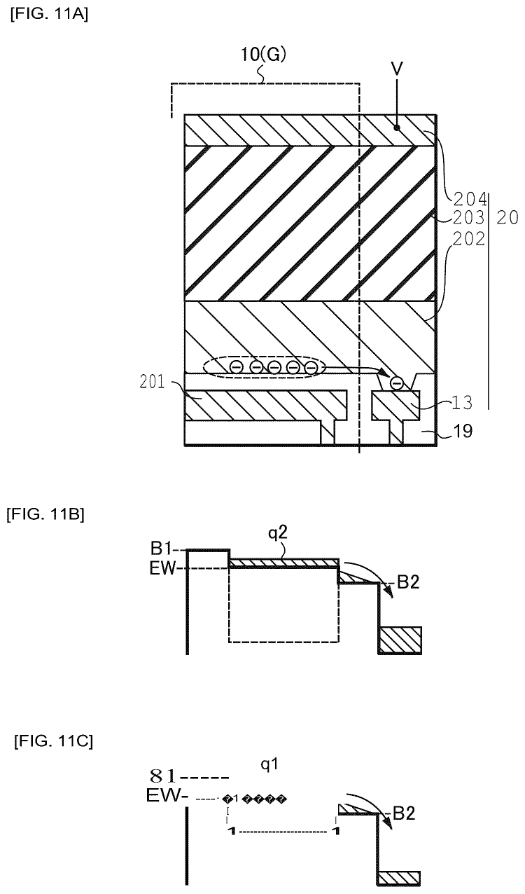

FIG. 11A illustrates an example of a schematic longitudinal cross-sectional configuration of the pixel 10 upon electric charge transfer. FIG. 11B illustrates an example of an energy potential in the state in which the first operating voltage V2 is supplied to the pixel 10. FIG. 11C illustrates an example of an energy potential in the state in which the second operating voltage VI is supplied to the pixel 10.

### (1) Photoelectric Conversion Operation

As illustrated in FIG. 9A, the operating voltage is supplied to, for example, the charge accumulation electrode 201 of the pixel 10(G).

Upon the normal shooting, the first operating voltage V2 is supplied to the charge accumulation electrode 201. Light incident on the photoelectric conversion layer 203 of the photoelectric converter 20 is converted into electric charge, and as illustrated in FIG. 9B, the electrons (−) are accumulated as the electric charge q2 in the charge accumulation/transfer layer 202.

In contrast, upon dynamic range driving, the second operating voltage V1 is supplied to the charge accumulation electrode 201. Light incident on the photoelectric conversion layer 203 of the photoelectric converter 20 is converted into electric charge, and as illustrated in FIG. 9C, the electrons (−) are accumulated as the electric charge q1 in the charge accumulation/transfer layer 202.

### (2) Electric Charge Accumulation Operation

As illustrated in FIG. 10A, the operating voltage is continuously supplied to the charge accumulation electrode 201 of the pixel 10(G).

Upon the normal shooting, the first operating voltage V2 is supplied to the charge accumulation electrode 201, and as illustrated in FIG. 10B, the electric charge q2 is continuously accumulated in the charge accumulation/transfer layer 202. The first operating voltage V2 is supplied to the charge accumulation electrode 201, thus making the energy potential well EB deeper, which makes it possible to accumulate a large amount of the electric charge q2.

In contrast, upon the dynamic range driving, the second operating voltage V1 is supplied to the charge accumulation electrode 201, and as illustrated in FIG. 10C, the electric charge q1 is continuously accumulated in the charge accumulation/transfer layer 202. The second operating voltage V1 is supplied to the charge accumulation electrode 201, thus making the energy potential well EB shallower, and making an amount of the accumulated electric charge q2 small.

### (3) Electric Charge Transfer Operation

As illustrated in FIG. 11A, an electric charge transfer operation of the pixel 10(G) starts. Upon the normal shooting, as illustrated in FIG. 10B, the energy potential well EB rises, and the electric charge q2 accumulated in the energy potential well EB is transferred to the floating diffusion 13 across the energy potential barrier B2.

In contrast, upon the dynamic range driving, as illustrated in FIG. 10C, the energy potential well EB rises, and the electric charge q1 accumulated in the energy potential well EB is transferred to the floating diffusion 13 across the energy potential barrier B2.

Upon the dynamic range driving, using a difference between the electric charge q2 and the electric charge q1 makes it possible to expand the dynamic range.

### Workings and Effects

The solid-state imaging device 1 according to the first embodiment includes the pixel 10 including the photoelectric conversion layer 203, the charge accumulation/transfer layer 202, the charge accumulation electrode 201, and the electrode 204, as illustrated in FIG. 2.

The photoelectric conversion layer 203 converts light into electric charge. The charge accumulation/transfer layer 202 is provided on the photoelectric conversion layer 203, and accumulates and transfers the electric charge. The charge accumulation electrode 201 is provided on the charge accumulation/transfer layer 202 on the side opposite to the photoelectric conversion layer 203. The electrode 204 is provided on the photoelectric conversion layer 203 on the side opposite to the charge accumulation/transfer layer 202.

Here, as illustrated in FIGS. 1, 3, and 4, the solid-state imaging device 1 further includes the operating voltage supply section 110. The operating voltage supply section 110 selectively supplies, to the pixel 10, the first operating voltage V2 or the second operating voltage V1 that is different from the first operating voltage V2.

In the solid-state imaging device 1 configured in such a manner, the first operating voltage V2 or the second operating voltage V1 to be supplied from the operating voltage supply section 110 to the pixel 10 makes it possible to expand the dynamic range and perform imaging. Accordingly, it is not necessary to configure a dedicated pixel arrangement including pixels formed with different areas.

In addition, upon the normal shooting, the areas of all the pixels 10 are equal, which makes resolution and the electric charge accumulation amount Qs constant. Further, the configurations of all the pixels 10 have symmetry, which makes it possible to improve oblique incidence resistance when the solid-state imaging device is applied to a longitudinal spectroscopic sensor. In addition, it is possible to form all the pixels 10 with the same area, which makes it possible to achieve miniaturization.

Accordingly, in the solid-state imaging device 1 according to the first embodiment, it is possible to expand the dynamic range and perform imaging without necessity of the dedicated pixel arrangement.

In addition, in the solid-state imaging device 1, as illustrated in FIG. 3, the plurality of pixels 10 is arranged, and the operating voltage supply section 110 supplies the first operating voltage V2 to all the plurality of pixels 10 arranged. This makes it possible for the solid-state imaging device 1 to achieve a normal shooting operation.

In addition, in the solid-state imaging device 1, as illustrated in FIG. 4, the operating voltage supply section 110 supplies the first operating voltage V2 to a part of the plurality of pixels 10 arranged, and supplies the second operating voltage V1 to another part of the plurality of pixels 10 arranged. This makes it possible for the solid-state imaging device 1 to achieve a dynamic range driving operation.

In addition, in the solid-state imaging device 1, as illustrated in FIGS. 5 and 6, the second operating voltage VI is lower than the first operating voltage V2. This makes it possible for the solid-state imaging device 1 to achieve the dynamic range driving operation.

In addition, in the solid-state imaging device 1, as illustrated in FIGS. 7 and 8, the operating voltage supply section 110 supplies one of the first operating voltage V2 and the second operating voltage VI to the charge accumulation electrode 201 of the pixel 10.

Basically, the charge accumulation electrode 201 is provided electrically independently for each pixel 10. Accordingly, just including the operating voltage supply section 110 makes it possible to expand the dynamic range and perform imaging without necessity of the dedicated pixel arrangement.

Further, in the solid-state imaging device 1, as illustrated in FIGS. 3 and 4, the operating voltage supply section 110 includes the voltage generator 111, the voltage supply section 112, and the voltage selector 113. The voltage generator 111 generates the first operating voltage V2 and the second operating voltage V1. The voltage supply section 112 supplies, to the pixel 10, one of the first operating voltage V2 and the second operating voltage VI generated by the voltage generator 111. The voltage selector 113 selects one of the first operating voltage V2 and the second operating voltage V1 to be supplied to the pixel 10 by the voltage supply section 112.

Including such an operating voltage supply section 110 makes it possible to expand the dynamic range and perform imaging without necessity of the dedicated pixel arrangement.

### 2. Second Embodiment

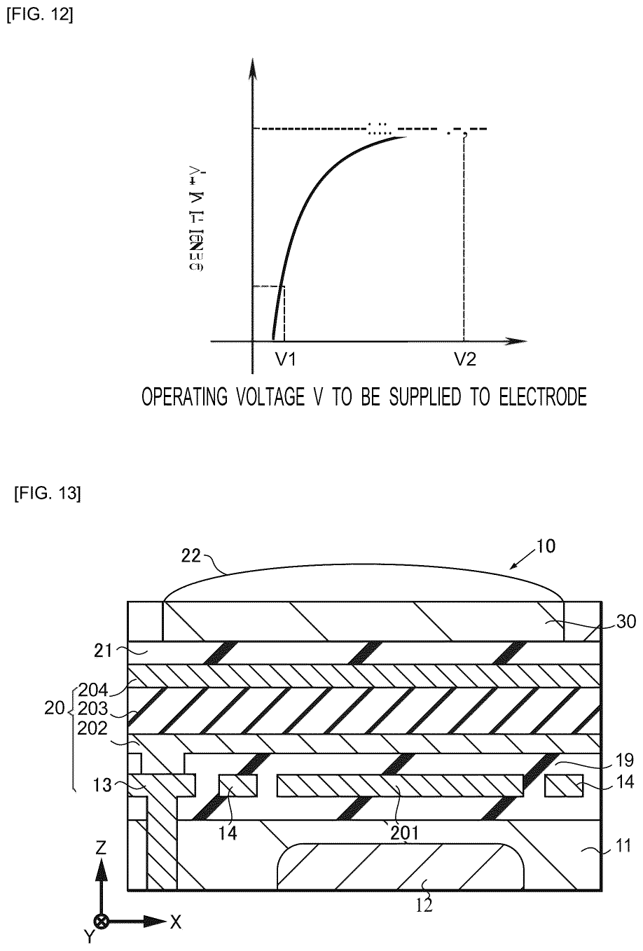

Description is given of the solid-state imaging device 1 according to the second embodiment of the present disclosure with reference to FIG. 12.

It is to be noted that, in the second embodiment and the subsequent embodiments, components the same or substantially the same as the components of the solid-state imaging device 1 according to the first embodiment are denoted by the same reference numerals, and redundant descriptions are omitted.

### Configuration of Solid-State Imaging Device 1

In the solid-state imaging device 1 according to the second embodiment, in the pixel 10 illustrated in FIG. 2 described above, one of the first operating voltage V2 and the second operating voltage V1 is supplied to the electrode 204 of the photoelectric converter 20. The first operating voltage V2 and the second operating voltage VI are supplied from the operating voltage supply section 110 illustrated in FIGS. 3 and 4 described above.

At this time, the electrode 204 is provided electrically independently for every plurality of pixels 10 selected by scanning. For example, in the pixel region 100 illustrated in FIG. 1 described above, the electrode 204 extends in the arrow-X direction for each column of the pixels 10, and a plurality of the electrodes 204 is arranged in the arrow-Y direction with a predetermined interval.

FIG. 12 illustrates an example relationship between the first operating voltage V2 and the second operating voltage VI that are to be supplied to the electrode 204 of the pixel, and sensitivity. In FIG. 12, a horizontal axis indicates an operating voltage V to be supplied to the electrode 204. Further, a vertical axis indicates sensitivity.

As illustrated in FIG. 12, sensitivity obtained by the first operating voltage V2 is higher than sensitivity obtained by the second operating voltage V1. Using this difference in sensitivity makes it possible to expand the dynamic range and perform imaging.

Components other than the above-described components are the same or substantially the same as the components of the solid-state imaging device 1 according to the first embodiment.

### Workings and Effects

In the solid-state imaging device 1 according to the second embodiment, in the pixel 10 illustrated in FIG. 2 described above, one of the first operating voltage V2 and the second operating voltage VI is supplied to the electrode 204 of the photoelectric converter 20.

In the solid-state imaging device 1 configured in such a manner, as with the solid-state imaging device 1 according to the first embodiment, it is possible to expand the dynamic range and perform imaging without necessity of the dedicated pixel arrangement.

It is to be noted that in the present technology, the solid-state imaging device 1 according to the first embodiment and the solid-state imaging device 1 according to the second embodiment may be combined.

### 3. Third Embodiment

Description is given of the solid-state imaging device 1 according to the third embodiment with reference to FIG. 13.

FIG. 13 illustrates an example of a longitudinal cross-sectional configuration of the pixel 10 of the solid-state imaging device 1.

### Configuration of Solid-State Imaging Device 1

As illustrated in FIG. 13, the solid-state imaging device 1 includes a color filter 30 in the pixel 10. Although a planar configuration is omitted, in the solid-state imaging device 1, two pixels 10 arranged in the arrow-X direction and two pixels 10 arranged in the arrow-Y direction configure a pixel unit, and a plurality of the pixel units is arranged.

The color filter 30 is provided between the protective film 21 and the optical lens 22 for each pixel 10. The color filter 30 allows red light (R), green light (G), or blue light (B) to selectively pass therethrough. For example, the color filter 30 that allows green light to selectively pass therethrough is provided for each of two pixels 10 arranged on one diagonal line of the pixel unit. In addition, the color filters 30 that each allow a corresponding one of red light and blue light to selectively pass therethrough are provided for two pixels arranged on another diagonal line of the pixel unit. That is, the pixels 10 are arranged in a Bayer pattern.

The photoelectric converter 20 detects light in a visible light region corresponding to each color of the color filter 30. Meanwhile, the photoelectric conversion region 12 detects light having a wavelength different from that of the light detected by the photoelectric converter 20. The light having the different wavelength is infrared light (IR) in an infrared light region having a wavelength of 700 nm or more and 1000 nm or less.

Components other than the above-described components in the third embodiment are the same or substantially the same as the components of the solid-state imaging device 1 according to the first embodiment or the second embodiment.

### Workings and Effects

In the solid-state imaging device 1 according to the third embodiment, it is possible to obtain workings and effects similar to the workings and effects obtained by the solid-state imaging device 1 according to the first embodiment or the second embodiment.

In addition, in the solid-state imaging device 1, it is possible to construct a phase difference detection pixel corresponding to visible light.

### 4. Fourth Embodiment

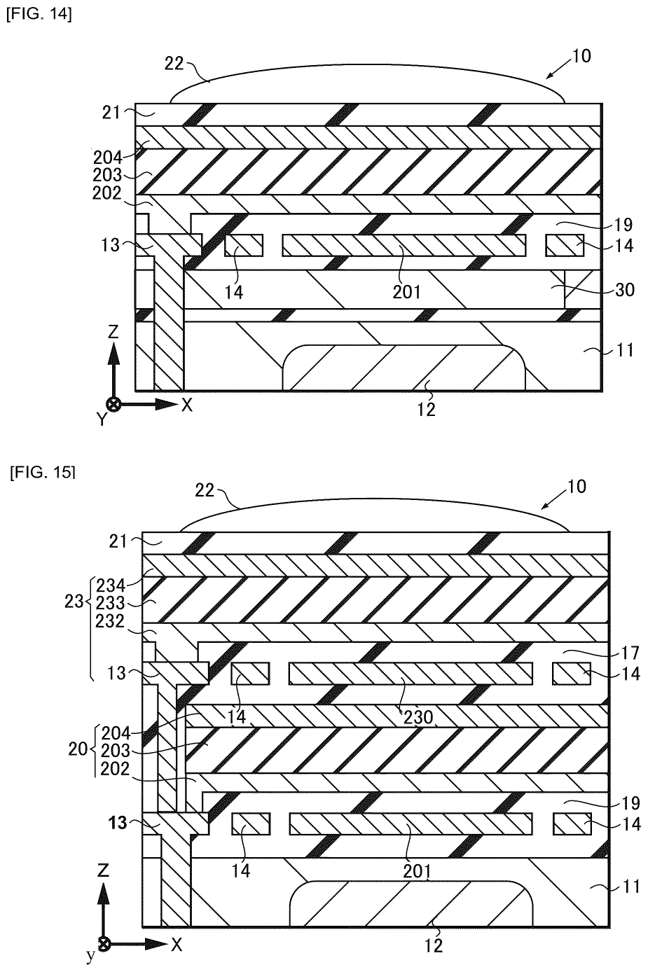

Description is given of the solid-state imaging device 1 according to the fourth embodiment with reference to FIG. 14.

FIG. 14 illustrates an example of a longitudinal cross-configuration of the pixel 10 of the solid-state imaging device 1.

### Configuration of Solid-State Imaging Device 1

As illustrated in FIG. 14, the solid-state imaging device 1 is a modification example of the solid-state imaging device 1 according to the third embodiment.

To describe this in detail, in the solid-state imaging device, the color filter 30 is provided between the photoelectric conversion region 12 and the photoelectric converter 20. The color filter 30 that allows the red light to selectively pass therethrough is provided for the two pixels 10 arranged on the one diagonal line of the pixel unit described above. Meanwhile, the color filter 30 that allows the blue light to selectively pass therethrough is provided for the two pixels 10 arranged on the other diagonal line of the pixel unit.

The photoelectric converter 20 is configured to selectively absorb the green light.

The photoelectric conversion region 12 obtains signals corresponding to the red light (R) and the blue light (B).

Components other than the above-described components in the fourth embodiment are the same or substantially the same as the components of the solid-state imaging device 1 according to the first embodiment or the second embodiment.

### Workings and Effects

In the solid-state imaging device 1 according to the fourth embodiment, it is possible to obtain workings and effects similar to the workings and effects obtained by the solid-state imaging device 1 according to the first embodiment or the second embodiment.

In addition, in the solid-state imaging device 1, it is possible to enlarge areas of the photoelectric conversion region 12 and the photoelectric converter 20 that detect the red light, the blue light, and the green light, as compared with a case of having a typical Bayer arrangement. Accordingly, it is possible to construct the phase difference detection pixel that makes it possible to improve an S/N ratio.

### 5. Fifth Embodiment

Description is given of the solid-state imaging device 1 according to the fifth embodiment of the present disclosure with reference to FIG. 15.

FIG. 15 illustrates an example of a longitudinal cross-sectional configuration of the pixel 10 of the solid-state imaging device 1.

### Configuration of Solid-State Imaging Device 1

As illustrated in FIG. 15, the solid-state imaging device 1 is a modification example of the solid-state imaging device 1 according to the first embodiment or the second embodiment.

To describe this in detail, the solid-state imaging device 1 further includes a photoelectric converter (a second organic photoelectric converter) 23 between the photoelectric converter (a first organic photoelectric converter) 20 and the optical lens 22 in the solid-state imaging device 1 according to the first embodiment. That is, the solid-state imaging device 1 constructs a stacked sensor in which the photoelectric conversion region 12, the photoelectric converter 20, and the photoelectric converter 23 are sequentially stacked.

The photoelectric conversion region 12 is, for example, a photoelectric converter that absorbs the red light having a wavelength of 600 nm or more and 700 nm or less and generates electric charge.

The photoelectric converter 20 is, for example, a photoelectric converter that absorbs the green light having a wavelength of 500 nm or more and less than 600 nm and generates electric charge.

Further, the photoelectric converter 23 is, for example, a photoelectric converter that absorbs the blue light having a wavelength of 400 nm or more and less than 500 nm and generates electric charge.

It is to be noted that, the stacking order of the organic photoelectric converter 20 and the photoelectric converter 23 may be replaced as appropriate.

As with the photoelectric converter 20, the photoelectric converter 23 includes a charge accumulation electrode 230, a charge accumulation/transfer layer 232, a photoelectric conversion layer 233, and an electrode 234. In the solid-state imaging device 1 according to the fifth embodiment, as with the solid-state imaging device 1 according to the first embodiment, one of the first operating voltage V2 and the second operating voltage VI is supplied to the charge accumulation electrode 230. In addition, in the solid-state imaging device 1 according to the fifth embodiment, as with the solid-state imaging device 1 according to the second embodiment, one of the first operating voltage V2 and the second operating voltage V1 may be supplied to the electrode 234.

Components other than the above-described components in the fifth embodiment are the same or substantially the same as the components of the solid-state imaging device 1 according to the first embodiment or the second embodiment.

### Workings and Effects

In the solid-state imaging device 1 according to the fifth embodiment, it is possible to obtain workings and effects similar to the workings and effects obtained by the solid-state imaging device 1 according to the first embodiment or the second embodiment.

In addition, the solid-state imaging device 1 has a stacked structure in which the photoelectric conversion region 12, the photoelectric converter 20, and the photoelectric converter 23 are sequentially stacked. Accordingly, in the solid-state imaging device 1, it is possible to easily construct a phase difference detection pixel that makes it possible to detect the red light, the blue light, and the green light.

### 6. Sixth Embodiment

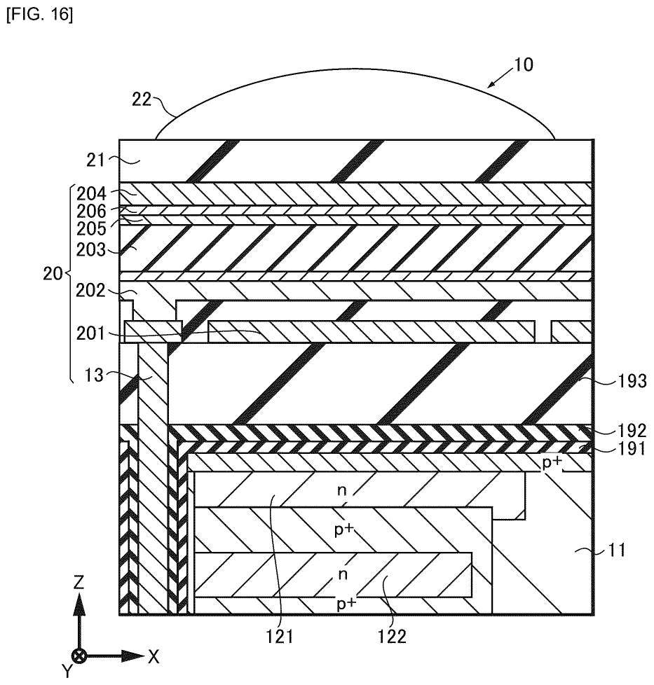

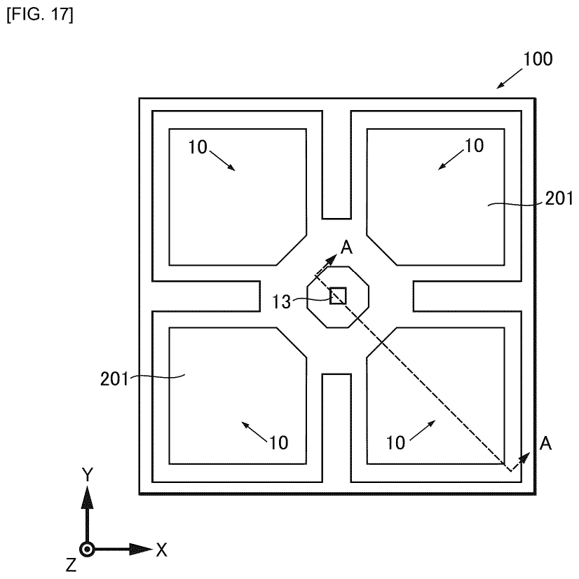

Description is given of the solid-state imaging device 1 according to the sixth embodiment of the present disclosure with reference to FIGS. 16 and 17.

FIG. 16 illustrates an example of a longitudinal cross-sectional configuration of the pixel 10 of the solid-state imaging device 1. FIG. 17 illustrates an example of a planar configuration of the pixel 10 illustrated in FIG. 16. FIG. 16 is a cross-sectional view taken along a cutting line A-A illustrated in FIG. 17.

In the pixel region 100 of the solid-state imaging device 1, for example, two pixels 10 arranged in the arrow-X direction and two pixels 10 arranged in the arrow-Y direction configure a pixel unit. The pixel units are repeatedly arranged in the arrow-X direction and the arrow-Y direction.

In the solid-state imaging device 1, one photoelectric converter 20 formed using, for example, an organic material, and two photoelectric conversion regions, i.e., a photoelectric conversion region 121 and a photoelectric conversion region 122 that are formed using, for example, an inorganic material, are stacked in a longitudinal direction. The one photoelectric converter 20 and the two photoelectric conversion regions 121 and 122 each selectively detect light in a corresponding one of wavelength ranges different from each other, and perform photoelectric conversion. That is, the solid-state imaging device 1 includes the pixels 10 of what is called a longitudinal-direction spectroscopic type.

The photoelectric converter 20 is provided on a back surface side of the semiconductor layer 11. The photoelectric conversion region 121 and the photoelectric conversion region 122 are embedded in the semiconductor layer 11. The photoelectric conversion region 121 and the photoelectric conversion region 122 are stacked in a thickness direction of the semiconductor layer 11.

The photoelectric converter 20, the photoelectric conversion region 121, and the photoelectric conversion region 122 each selectively detect light in a corresponding one of the wavelength ranges different from each other, and perform photoelectric conversion. For example, the photoelectric converter 20 obtains a green color signal. The photoelectric conversion region 121 and the photoelectric conversion region 122 respectively obtain a blue color signal and a red color signal depending on a difference in absorption coefficients.

In the solid-state imaging device 1 configured in such a manner, it is possible to obtain a plurality of types of color signals in one pixel without using color filters.

The protective film 21 is provided above the photoelectric converter 20. For example, a light-blocking film, a wiring that electrically couples the electrode 204 and a peripheral circuit section to each other, and the like are provided in the protective film 21, although a detailed configuration and description thereof are omitted. An unillustrated planarization film, an optical member such as the optical lens 22 are provided above the protective film 21.

Next, configurations, materials, and the like of respective components will be described in detail below.

In the photoelectric converter 20, a hole blocking layer 205, the photoelectric conversion layer 203, an electron blocking layer 206, and a work function adjustment layer 207 are stacked in this order between the charge accumulation electrode 201 and the electrode 204 that are provided to be opposed to each other. The charge accumulation electrode 201 includes a plurality of electrodes, e.g., two electrodes including a readout electrode with no reference numeral and an accumulation electrode with no reference numeral. For example, the insulator 19 and the charge accumulation/transfer layer 202 are stacked in this order between the charge accumulation electrode 201 and the hole blocking layer 205. In the charge accumulation electrode 201, the readout electrode is electrically coupled to the charge accumulation/transfer layer 202.

The readout electrode transfers electric charge generated in the photoelectric conversion layer 203 to the floating diffusion 13 (see FIG. 2).

The accumulation electrode is provided in a region that is directly opposed to the light receiving surfaces of the photoelectric conversion regions 121 and 122 formed in the semiconductor layer 11 and that covers these light receiving surfaces. The accumulation electrode is larger than the readout electrode. This makes it possible to accumulate a large amount of electric charge.

The insulator 19 electrically separates the charge accumulation/transfer layer 202 from the accumulation electrode. The insulator 19 is formed on, for example, the semiconductor layer 11 to cover the charge accumulation electrode 201.

The insulator 19 is formed by, for example, a monolayer film including one selected from among silicon oxide (SiOₓ), silicon nitride (SiNₓ), and silicon oxynitride (SiOₓN_{y}), or a composite film including two or more thereof. The insulator 19 has, for example, a thickness of 20 nm or more and 500 nm or less.

The charge accumulation/transfer layer 202 accumulates signal charge generated in the photoelectric conversion layer 203. The charge accumulation/transfer layer 202 is formed using, for example, a material having higher electric charge mobility than the photoelectric conversion layer 203 and having a large bandgap. Specifically, the bandgap of the constituent material of the charge accumulation/transfer layer 202 is 3.0 eV or more. Examples of such a material include an oxide semiconductor such as IGZO, an organic semiconductor, and the like. Examples of the organic semiconductor include transition metal dichalcogenide, silicon carbide, diamond, graphene, a carbon nano-tube (Carbon Nano Tube), a condensed polycyclic hydrocarbon compound, a condensed heterocyclic compound, and the like. The charge accumulation/transfer layer 202 has, for example, a thickness of 10 nm or more and 300 nm or less. Providing the charge accumulation/transfer layer 202 including the above-described material between the charge accumulation electrode 201 and the photoelectric conversion layer 203 makes it possible to prevent electric charge recombination upon electric charge accumulation, thus making it possible to improve transfer efficiency.

It is to be noted that, in the sixth embodiment, the charge accumulation/transfer layer 202, the hole blocking layer 205, the photoelectric conversion layer 203, the electron blocking layer 206, the work function adjustment layer 207, and the electrode 204 are each a continuous layer common to a plurality of unit pixels. The present technology is not limited to the such a configuration. For example, in the present technology, the charge accumulation/transfer layer 202, the hole blocking layer 205, the photoelectric conversion layer 203, the electron blocking layer 206, the work function adjustment layer 207, and the electrode 204 may each be separately formed for each unit pixel.

For example, a fixed charge layer 191 having fixed electric charge, a dielectric layer 192 having an insulation property, and an interlayer insulating layer 193 are formed in this order from the semiconductor layer 11 between the semiconductor layer 11 and the charge accumulation electrode 201.

The fixed charge layer 191 may be a film having positive fixed electric charge, or may be a film having negative fixed electric charge. It is possible to form the fixed charge layer 191 using, as a constituent material of the fixed charge layer 191, a semiconductor or an electrically-conductive material having a wider bandgap than that of the semiconductor layer 11. This makes it possible to suppress generation of a dark current at an interface of the semiconductor layer 11.

Examples of the constituent material of the fixed charge layer 191 include hafnium oxide (HfOₓ), aluminum oxide (AlOₓ), zirconium oxide (ZrOₓ), tantalum oxide (TaOₓ), titanium oxide (TiOₓ), lanthanum oxide (LaOₓ), praseodymium oxide (PrOₓ), cerium oxide (CeOₓ), neodymium oxide (NdOₓ), promethium oxide (PmOₓ), samarium oxide (SmOₓ), europium oxide (EuOₓ), gadolinium oxide (GdOₓ), terbium oxide (TbOₓ), dysprosium oxide (DyOₓ), holmium oxide (HoOₓ), thulium oxide (TmOₓ), ytterbium oxide (YbOₓ), lutetium oxide (LuOₓ), yttrium oxide (YOₓ), hafnium nitride (HfNₓ), aluminum nitride (AlNₓ), hafnium oxynitride (HfOₓN_{y}), and aluminum oxynitride (AlOₓN_{y}).

The dielectric layer 192 prevents light reflection caused by a refractive index difference between the semiconductor layer 11 and the interlayer insulating layer 193. It is preferable to use, for the dielectric layer 192, a material having a refractive index between a refractive index of the semiconductor layer 11 and a refractive index of the interlayer insulating layer 193. Examples of the material of the dielectric layer 192 include SiOₓ, TEOS, SiNₓ, SiOₓN_{y}, and the like.

The interlayer insulating layer 193 is formed by, for example, a monolayer film including one selected from among SiOₓ, SiNₓ, and SiOₓN_{y}, or a composite film including two or more thereof.

The photoelectric conversion region 121 and the photoelectric conversion region 122 each include, for example, a PIN (Positive Intrinsic Negative) type photodiode. A p-n junction that forms each of the photoelectric conversion region 121 and the photoelectric conversion region 122 is provided in a predetermined region of the semiconductor layer 11. The photoelectric conversion region 121 and the photoelectric conversion region 122 allow light to be dispersed in the longitudinal direction by utilizing a difference in wavelength ranges to be absorbed in accordance with a light incidence depth in the semiconductor layer 11.

The photoelectric conversion region 121 selectively detects the blue light and accumulates signal charge corresponding to blue. The photoelectric conversion region 121 is formed at a depth at which the blue light is allowed to be efficiently photoelectrically converted.

The photoelectric conversion region 122 selectively detects the red light and accumulates signal charge corresponding to red. The photoelectric conversion region 122 is formed at a depth at which the red light is allowed to be efficiently photoelectrically converted.

It is to be noted that blue is a color corresponding to a wavelength range of 400 nm or more and less than 495 nm, for example. In contrast, red is a color corresponding to a wavelength range of 620 nm or more and less than 750 nm, for example. Each of the photoelectric conversion region 121 and the photoelectric conversion region 122 is formed to allow for detection of light in a part or the whole of a corresponding one of the wavelength ranges.

Specifically, as illustrated in FIG. 16, each of the photoelectric conversion region 121 and the photoelectric conversion region 122 includes, for example, a p+-type semiconductor region serving as a hole accumulation layer and an n-type semiconductor region serving as an electron accumulation layer (having a p-n-p stacked structure).

The protective film 21 and the optical lens 22 are formed by a material having light transmissivity. The protective film 21 and the optical lens 22 are each formed by, for example, a monolayer film including one selected from among SiOₓ, SiNₓ, and SiOₓN_{y}, or a composite film including two or more thereof. The protective film 21 has a thickness of 100 nm or more and 30000 nm or less, for example.

### 7. Seventh Embodiment

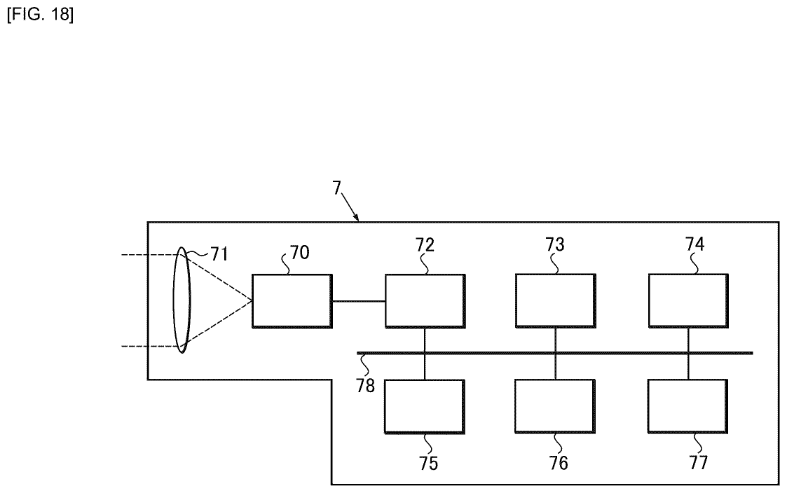

Description is given of the solid-state imaging device 1 according to the seventh embodiment of the present disclosure with reference to FIG. 18.

FIG. 18 illustrates an example of a block configuration of an electronic apparatus 7.

### Configuration of Electronic Apparatus 7

As illustrated in FIG. 18, the electronic apparatus 7 includes, as a photodetector 70, the solid-state imaging device 1 according to any of the first embodiment to the sixth embodiment. The photodetector 70 is applied, for example, to various types of electronic apparatuses including an imaging system such as a digital still camera and a video camera, a mobile phone having an imaging function, or another device having an imaging function.

The electronic apparatus 7 includes an optical system 71, the photodetector 70, and a DSP (Digital Signal Processor) 72. In the electronic apparatus 7, the DSP 72, a display device 73, an operation system 74, a memory 75, a recording device 76, and a power supply system 77 are coupled to one another via a bus 78. The electronic apparatus 7 is able to capture a still image and a moving image.

The optical system 71 includes one or a plurality of lenses. The optical system 71 guides image light (incident light) from a subject to the photodetector 70 to form an image on a light-receiving surface (a sensor section) of the photodetector 70.

For example, the solid-state imaging device 1 according to any of the first embodiment to the sixth embodiment is used as the photodetector 70. In the photodetector 70, electrons are accumulated for a certain period of time in response to an image formed on the light-receiving surface through the optical system 71. Thereafter, the DSP 72 is supplied with a signal corresponding to the electrons accumulated in the photodetector 70.

The DSP 72 performs various types of signal processing on the signal from the photodetector 70 to obtain an image, and causes data of the image to be temporarily stored in the memory 75. The data of the image stored in the memory 75 is recorded in the recording device 76. In addition, the data of the image stored in the memory 75 is supplied to the display device 73, and the image is displayed on the display device 73. In addition, the operation system 74 accepts various operations by a user, and supplies an operation signal to each of blocks of the electronic apparatus 7. The power supply system 77 supplies electric power necessary for driving each of the blocks of the electronic apparatus 7.

### Workings and Effects

As illustrated in FIG. 18, the electronic apparatus 7 according to the seventh embodiment includes the photodetector 70. As described for the solid-state imaging device 1 according to any of the first embodiment to the sixth embodiment, the photodetector 70 includes the operating voltage supply section 110, for example. It is therefore possible to expand a dynamic range of the electronic apparatus 7.

### 8. Eighth Embodiment

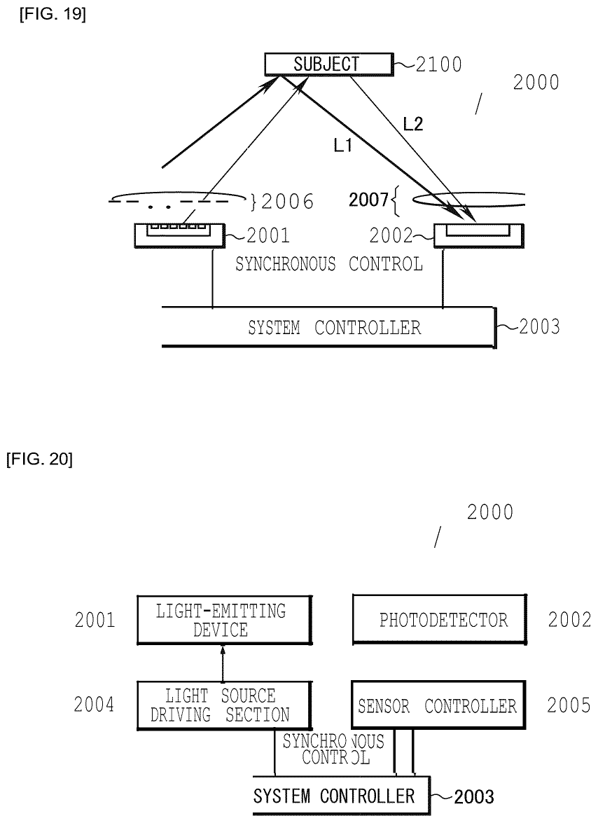

Description is given of a photodetection system 2000 according to the eighth embodiment of the present disclosure with reference to FIGS. 19 and 20.

FIG. 19 illustrates an example of a system configuration of the photodetection system 2000 including a photodetector 2002. FIG. 20 illustrates an example of a circuit configuration of the photodetection system 2000 illustrated in FIG. 19.

The photodetection system 2000 includes a light-emitting device 2001 as a light source section that emits infrared light L2 and a photodetector 2002 as a light-receiving section including a photoelectric conversion element. As the photodetector 2002, it is possible to use the solid-state imaging device 1 described above. The photodetection system 2000 further includes a system controller 2003, a light source driving section 2004, a sensor controller 2005, a light source-side optical system 2006, and a camera-side optical system 2007.

The photodetector 2002 is able to detect light L1 and light L2. The light L1 is ambient light from outside reflected by a subject (a measurement object) 2100. The light L2 is light emitted from the light-emitting device 2001 and then reflected by the subject 2100. The light L1 is, for example, visible light, and the light L2 is, for example, infrared light. The light L1 is detectable in a photoelectric converter in the photodetector 2002. The light L2 is detectable in a photoelectric conversion region in the photodetector 2002. It is possible to obtain image information of the subject 2100 from the light L1 and obtain distance information between the subject 2100 and the photodetection system 2000 from the light L2.

It is possible to mount the photodetection system 2000 on, for example, an electronic apparatus such as a smartphone and a mobile body such as a car. It is possible to configure the light-emitting device 2001 with, for example, a semiconductor laser, a surface-emitting semiconductor laser, or a vertical cavity surface emitting laser (VCSEL).

As a method of detecting the light L2 emitted from the light-emitting device 2001 by the photodetector 2002, for example, it is possible to adopt, for example, an iTOF method; however, the method is not limited thereto. In the iTOF method, the photoelectric converter measures a distance to the subject 2100 by time of flight (Time-of-Flight; TOF), for example. As a method of detecting the light L2 emitted from the light-emitting device 2001 by the photodetector 2002, it is possible to adopt, for example, a structured light method or a stereovision method.

For example, in the structured light method, light having a predetermined pattern is projected on the subject 2100, and distortion of the pattern is analyzed, thereby making it possible to measure the distance between the photodetection system 2000 and the subject 2100.

In addition, in the stereovision method, for example, two or more cameras are used to obtain two or more images of the subject 2100 viewed from two or more different viewpoints, thereby making it possible to measure the distance between the photodetection system 2000 and the subject 2100. It is to be noted that it is possible to synchronously control the light-emitting device 2001 and the photodetector 2002 by the system controller 2003.

### 9. Example of Application to Mobile Body

The technology (present technology) according to the present disclosure is applicable to various products. For example, the technology according to the present disclosure may be achieved in the form of an apparatus to be mounted to a mobile body of any kind such as an automobile, an electric vehicle, a hybrid electric vehicle, a motorcycle, a bicycle, a personal mobility, an airplane, a drone, a vessel, and a robot.

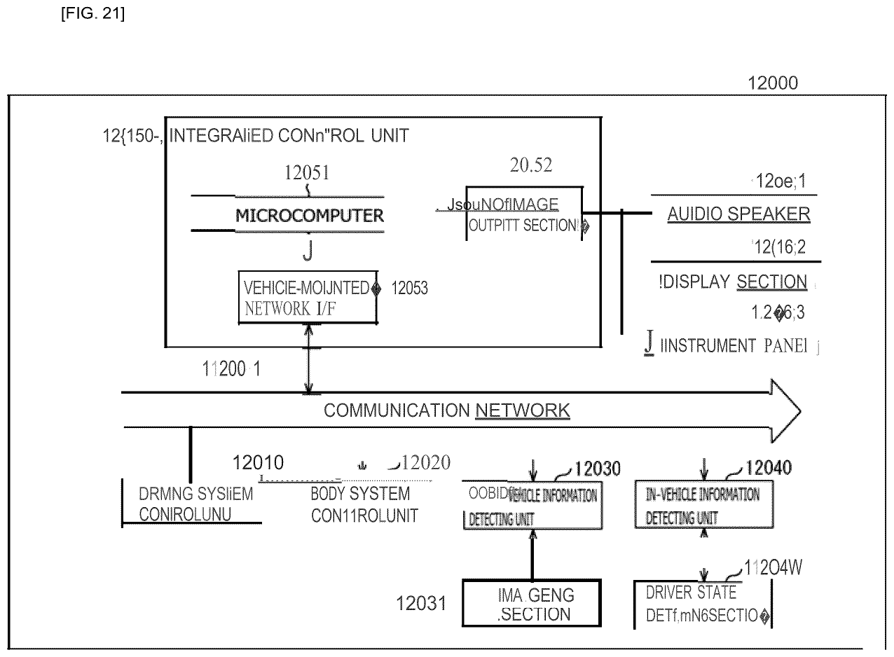

FIG. 21 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 21, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 21, an audio speaker 12061, a display section 12062, and an instrument panel 12063 are illustrated as the output device. The display section 12062 may, for example, include at least one of an on-board display and a head-up display.

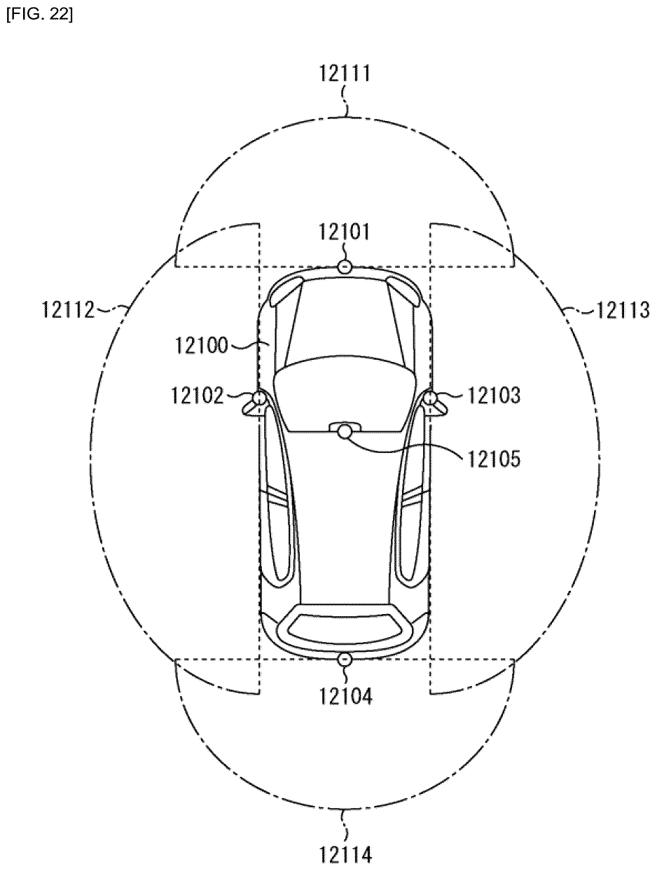

FIG. 22 is a diagram depicting an example of the installation position of the imaging section 12031.

In FIG. 22, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 22 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The description has been given hereinabove of one example of the vehicle control system, to which the technology according to the present disclosure may be applied. The technology according to the present disclosure may be applied to the imaging section 12031 among the configurations described above. The application of the technology according to the present disclosure to the imaging section 12031 enables achievement of the imaging section 12031 of a simpler configuration.

### 10. Example of Application to Endoscopic Surgery System

The technology according to the present disclosure (present technology) is applicable to various products. For example, the technology according to the present disclosure may be applied to an endoscopic surgery system.

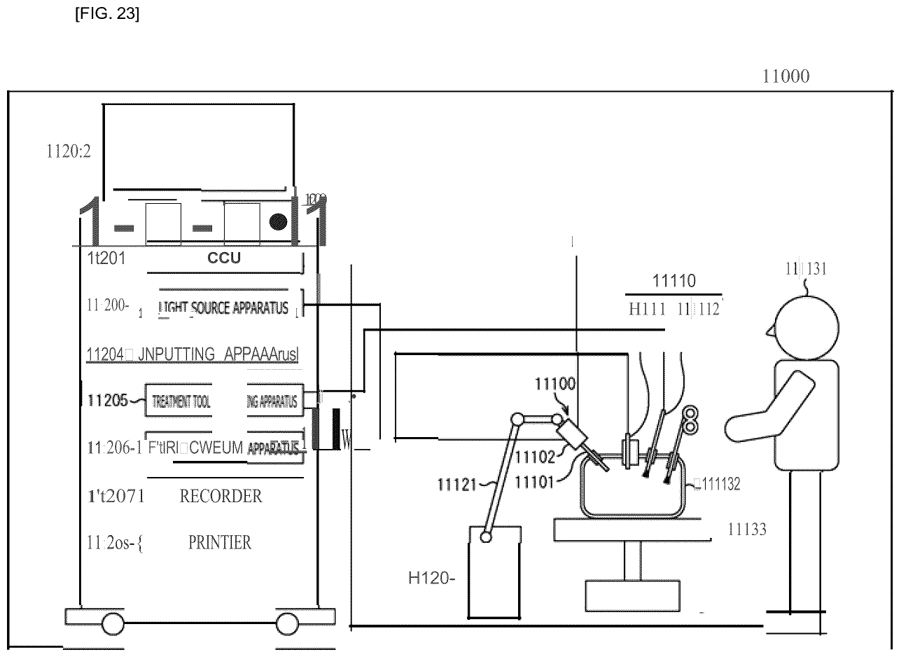

FIG. 23 is a view depicting an example of a schematic configuration of an endoscopic surgery system to which the technology according to an embodiment of the present disclosure (present technology) can be applied.

In FIG. 23, a state is illustrated in which a surgeon (medical doctor) 11131 is using an endoscopic surgery system 11000 to perform surgery for a patient 11132 on a patient bed 11133. As depicted, the endoscopic surgery system 11000 includes an endoscope 11100, other surgical tools 11110 such as a pneumoperitoneum tube 11111 and an energy device 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted into a body cavity of the patient 11132, and a camera head 11102 connected to a proximal end of the lens barrel 11101. In the example depicted, the endoscope 11100 is depicted which includes as a rigid endoscope having the lens barrel 11101 of the hard type. However, the endoscope 11100 may otherwise be included as a flexible endoscope having the lens barrel 11101 of the flexible type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel 11101 by a light guide extending in the inside of the lens barrel 11101 and is irradiated toward an observation target in a body cavity of the patient 11132 through the objective lens. It is to be noted that the endoscope 11100 may be a forward-viewing endoscope or may be an oblique-viewing endoscope or a side-viewing endoscope.

An optical system and an image pickup element are provided in the inside of the camera head 11102 such that reflected light (observation light) from the observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a CCU 11201.

The CCU 11201 includes a central processing unit (CPU), a graphics processing unit (GPU) or the like and integrally controls operation of the endoscope 11100 and a display apparatus 11202. Further, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 includes a light source such as, for example, a light emitting diode (LED) and supplies irradiation light upon imaging of a surgical region to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal distance or the like) by the endoscope 11100.

A treatment tool controlling apparatus 11205 controls driving of the energy device 11112 for cautery or incision of a tissue, sealing of a blood vessel or the like. A pneumoperitoneum apparatus 11206 feeds gas into a body cavity of the patient 11132 through the pneumoperitoneum tube 11111 to inflate the body cavity in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a white light source which includes, for example, an LED, a laser light source or a combination of them. Where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203. Further, in this case, if laser beams from the respective RGB laser light sources are irradiated time-divisionally on an observation target and driving of the image pickup elements of the camera head 11102 are controlled in synchronism with the irradiation timings. Then images individually corresponding to the R, G and B colors can be also picked up time-divisionally. According to this method, a color image can be obtained even if color filters are not provided for the image pickup element.

Further, the light source apparatus 11203 may be controlled such that the intensity of light to be outputted is changed for each predetermined time. By controlling driving of the image pickup element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to irradiate light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 11203 can be configured to supply such narrow-band light and/or excitation light suitable for special light observation as described above.

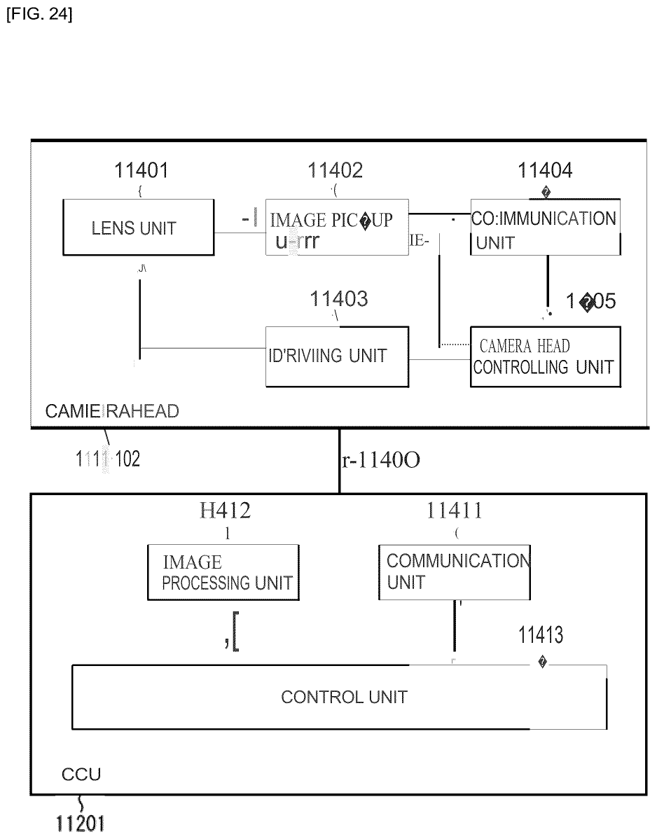

FIG. 24 is a block diagram depicting an example of a functional configuration of the camera head 11102 and the CCU 11201 depicted in FIG. 23.

The camera head 11102 includes a lens unit 11401, an image pickup unit 11402, a driving unit 11403, a communication unit 11404 and a camera head controlling unit 11405. The CCU 11201 includes a communication unit 11411, an image processing unit 11412 and a control unit 11413. The camera head 11102 and the CCU 11201 are connected for communication to each other by a transmission cable 11400.

The lens unit 11401 is an optical system, provided at a connecting location to the lens barrel 11101. Observation light taken in from a distal end of the lens barrel 11101 is guided to the camera head 11102 and introduced into the lens unit 11401. The lens unit 11401 includes a combination of a plurality of lenses including a zoom lens and a focusing lens.

The number of image pickup elements which is included by the image pickup unit 11402 may be one (single-plate type) or a plural number (multi-plate type). Where the image pickup unit 11402 is configured as that of the multi-plate type, for example, image signals corresponding to respective R, G and B are generated by the image pickup elements, and the image signals may be synthesized to obtain a color image. The image pickup unit 11402 may also be configured so as to have a pair of image pickup elements for acquiring respective image signals for the right eye and the left eye ready for three dimensional (3D) display. If 3D display is performed, then the depth of a living body tissue in a surgical region can be comprehended more accurately by the surgeon 11131. It is to be noted that, where the image pickup unit 11402 is configured as that of stereoscopic type, a plurality of systems of lens units 11401 are provided corresponding to the individual image pickup elements.

Further, the image pickup unit 11402 may not necessarily be provided on the camera head 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405. Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes information relating to image pickup conditions such as, for example, information that a frame rate of a picked up image is designated, information that an exposure value upon image picking up is designated and/or information that a magnification and a focal point of a picked up image are designated.

It is to be noted that the image pickup conditions such as the frame rate, exposure value, magnification or focal point may be designated by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 controls, on the basis of an image signal for which image processes have been performed by the image processing unit 11412, the display apparatus 11202 to display a picked up image in which the surgical region or the like is imaged. Thereupon, the control unit 11413 may recognize various objects in the picked up image using various image recognition technologies. For example, the control unit 11413 can recognize a surgical tool such as forceps, a particular living body region, bleeding, mist when the energy device 11112 is used and so forth by detecting the shape, color and so forth of edges of objects included in a picked up image. The control unit 11413 may cause, when it controls the display apparatus 11202 to display a picked up image, various kinds of surgery supporting information to be displayed in an overlapping manner with an image of the surgical region using a result of the recognition. Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication or a composite cable ready for both of electrical and optical communications.

Here, while, in the example depicted, communication is performed by wired communication using the transmission cable 11400, the communication between the camera head 11102 and the CCU 11201 may be performed by wireless communication.

The description has been given above of one example of the endoscopic surgery system, to which the technology according to the present disclosure may be applied. The technology according to the present disclosure may be applied to, for example, the image pickup unit 11402 among the configurations described above. Specifically, the application of the technology according to the present disclosure to the image pickup unit 11402 makes it possible to expand a dynamic range and perform imaging without necessity of a dedicated pixel arrangement.

It is to be noted that although the endoscopic surgery system has been described as an example here, the technology according to the present disclosure may also be applied to, for example, a microscopic surgery system, and the like.

### 11. Other Embodiments

The present technology is not limited to the embodiments described above, and various modifications may be made without departing from the gist of the present technology.

For example, the solid-state imaging devices according to two or more embodiments, among the solid-state imaging devices according to the first embodiment to the fifth embodiment described above, may be combined.

A solid-state imaging device according to a first aspect of the present disclosure includes a pixel including a photoelectric conversion layer, a charge accumulation/transfer layer, a charge accumulation electrode, and an electrode.

The photoelectric conversion layer converts light into electric charge. The charge accumulation/transfer layer is provided on the photoelectric conversion layer, and accumulates and transfers electric charge. The charge accumulation electrode is provided on the charge accumulation/transfer layer on a side opposite to the photoelectric conversion layer. The electrode is provided on the photoelectric conversion layer on a side opposite to the charge accumulation/transfer layer.

Here, the solid-state imaging device further includes an operating voltage supply section. The operating voltage supply section selectively supplies, to the pixel, a first operating voltage or a second operating voltage different from the first operating voltage.

In the solid-state imaging device configured in such a manner, it is possible to expand a dynamic range and perform imaging by the first operating voltage or the second operating voltage to be supplied from the operating voltage supply section to the pixel. It is therefore possible to expand the dynamic range and perform imaging without necessity of a dedicated pixel arrangement.

In a solid-state imaging device according to a second aspect of the present disclosure, the operating voltage supply section supplies the first operating voltage to a part of a plurality of pixels arranged, and supplies the second operating voltage to another part of the plurality of pixels arranged, in the solid-state imaging device according to the first aspect.

In the solid-state imaging device configured in such a manner, it is possible to achieve a dynamic range driving operation.

In a solid-state imaging device according to a third aspect of the present disclosure, the operating voltage supply section is constructed to include a voltage generator, a voltage supply section, and a voltage selector, in the solid-state imaging device according to the first aspect.

The voltage generator generates the first operating voltage and the second operating voltage. The voltage supply section supplies, to the pixel, one of the first operating voltage and the second operating voltage generated by the voltage generator. The voltage selector selects one of the first operating voltage and the second operating voltage to be supplied to the pixel by the voltage supply section.

The solid-state imaging device configured in such a manner includes the operating voltage supply section, which makes it possible to expand the dynamic range and perform imaging without necessity of the dedicated pixel arrangement.

### Configuration of Present Technology

The present technology has the following configurations. According to the present technology having the following configurations, it is possible, in a solid-state imaging device, to expand a dynamic range and perform imaging with no necessity of a dedicated pixel arrangement.
(1)

A solid-state imaging device including:
a pixel; and
an operating voltage supply section, in which
the pixel includes
a photoelectric conversion layer that converts light into electric charge,
a charge accumulation/transfer layer that is provided on the photoelectric conversion layer, and accumulates and transfers the electric charge,
a charge accumulation electrode provided on the charge accumulation/transfer layer on a side opposite to the photoelectric conversion layer, and
an electrode provided on the photoelectric conversion layer on a side opposite to the charge accumulation/transfer layer, and
the operating voltage supply section selectively supplies one of a first operating voltage and a second operating voltage to the pixel, the second operating voltage being different from the first operating voltage.
(2)

The solid-state imaging device according to (1), in which
a plurality of the pixels is arranged, and
the operating voltage supply section supplies the first operating voltage to all of the plurality of pixels arranged.
(3)

The solid-state imaging device according to (1) or (2), in which the operating voltage supply section supplies the first operating voltage to a part of a plurality of pixels arranged, and supplies the second operating voltage to another part of the plurality of pixels arranged.
(4)

The solid-state imaging device according to any one of (1) to (3), in which the second operating voltage is lower than the first operating voltage.
(5)

The solid-state imaging device according to any one of (1) to (4), in which the operating voltage supply section supplies one of the first operating voltage and the second operating voltage to the charge accumulation electrode.
(6)

The solid-state imaging device according to (5), in which the charge accumulation electrode is provided electrically independently for each pixel.
(7)

The solid-state imaging device according to any one of (1) to (6), in which the operating voltage supply section supplies one of the first operating voltage and the second operating voltage to the electrode.
(8)

The solid-state imaging device according to (7), in which the electrode is provided electrically independently for every plurality of the pixels selected by scanning.
(9)

The solid-state imaging device according to any one of (1) to (8), in which
the operating voltage supply section is constructed to include
a voltage generator that generates the first operating voltage and the second operating voltage,
a voltage supply section that supplies, to the pixel, one of the first operating voltage and the second operating voltage generated by the voltage generator, and
a voltage selector that selects one of the first operating voltage and the second operating voltage to be supplied to the pixel by the voltage supply section.
(10)

The solid-state imaging device according to any one of (1) to (9), in which the photoelectric conversion layer is formed by an organic material or an inorganic material.
(11)

The solid-state imaging device according to any one of (1) to (10), in which the charge accumulation/transfer layer is formed by one or more materials selected from among IGZO, IGSiO, and IAZO.
(12)

The solid-state imaging device according to any one of (1) to (11), in which the charge accumulation electrode is formed by a material including IZO or ITO.
(13)

The solid-state imaging device according to any one of (1) to (12), in which the electrode is formed by a material including IZO or ITO.
(14)

The solid-state imaging device according to any one of (1) to (13), in which an inorganic photoelectric converter is provided, with a color filter interposed therebetween, on the charge accumulation electrode on a side opposite to the photoelectric conversion layer.
(15)

The solid-state imaging device according to any one of (1) to (14), in which an optical lens is provided on the electrode on a side opposite to the photoelectric conversion layer.

The present application claims the benefit of Japanese Priority Patent Application JP 2022-183411 filed with the Japan Patent Office on Nov. 16, 2022, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A solid-state imaging device comprising:
a pixel; and
an operating voltage supply section, wherein
the pixel includes
a photoelectric conversion layer that converts light into electric charge,
a charge accumulation/transfer layer that is provided on the photoelectric conversion layer, and accumulates and transfers the electric charge,
a charge accumulation electrode provided on the charge accumulation/transfer layer on a side opposite to the photoelectric conversion layer, and
an electrode provided on the photoelectric conversion layer on a side opposite to the charge accumulation/transfer layer, and
the operating voltage supply section selectively supplies one of a first operating voltage and a second operating voltage to the pixel, the second operating voltage being different from the first operating voltage.

2. The solid-state imaging device according to claim 1, wherein
a plurality of the pixels is arranged, and
the operating voltage supply section supplies the first operating voltage to all of the plurality of pixels arranged.

3. The solid-state imaging device according to claim 1, wherein the operating voltage supply section supplies the first operating voltage to a part of a plurality of pixels arranged, and supplies the second operating voltage to another part of the plurality of pixels arranged.

4. The solid-state imaging device according to claim 1, wherein the second operating voltage is lower than the first operating voltage.

5. The solid-state imaging device according to claim 1, wherein the operating voltage supply section supplies one of the first operating voltage and the second operating voltage to the charge accumulation electrode.

6. The solid-state imaging device according to claim 5, wherein the charge accumulation electrode is provided electrically independently for each pixel.

7. The solid-state imaging device according to claim 1, wherein the operating voltage supply section supplies one of the first operating voltage and the second operating voltage to the electrode.

8. The solid-state imaging device according to claim 7, wherein the electrode is provided electrically independently for every plurality of the pixels selected by scanning.

9. The solid-state imaging device according to claim 1, wherein
the operating voltage supply section is constructed to include
a voltage generator that generates the first operating voltage and the second operating voltage,
a voltage supply section that supplies, to the pixel, one of the first operating voltage and the second operating voltage generated by the voltage generator, and
a voltage selector that selects one of the first operating voltage and the second operating voltage to be supplied to the pixel by the voltage supply section.

10. The solid-state imaging device according to claim 1, wherein the photoelectric conversion layer is formed by an organic material or an inorganic material.

11. The solid-state imaging device according to claim 1, wherein the charge accumulation/transfer layer is formed by one or more materials selected from among IGZO, IGSiO, and IAZO.

12. The solid-state imaging device according to claim 1, wherein the charge accumulation electrode is formed by a material including IZO or ITO.

13. The solid-state imaging device according to claim 1, wherein the electrode is formed by a material including IZO or ITO.

14. The solid-state imaging device according to claim 1, wherein an inorganic photoelectric converter is provided, with a color filter interposed therebetween, on the charge accumulation electrode on a side opposite to the photoelectric conversion layer.

15. The solid-state imaging device according to claim 1, wherein an optical lens is provided on the electrode on a side opposite to the photoelectric conversion layer.
